(19) United States
(12) Patent Application Publication
(10) Pub. No.: US 2012/0178013 A1
(43) Pub. Date: Jul. 12, 2012

(54) CATALYST COATED MEMBRANE FOR FUEL CELL, MEMBRANE AND ELECTRODE ASSEMBLY (MEA) INCLUDING SAME, METHOD OF MANUFACTURING THE MEA, AND FUEL CELL INCLUDING THE MEA

(75) Inventors: Yoon-hoi Lee, Hwaseong-si (KR); Jung-ock Park, Yongin-si (KR); Seong-woo Choi, Yongin-si (KR)

(73) Assignee: Samsung Electronics Co. Ltd., Suwon-si (KR)

(21) Appl. No.: 13/229,143

(22) Filed: Sep. 9, 2011

(30) Foreign Application Priority Data
Jan. 6, 2011 (KR) 10-2011-0001550

(51) Int. Cl. H01M 8/10; H01M 8/00

(52) U.S. Cl. 429/480; 429/482; 429/535

(57) ABSTRACT

A catalyst coated membrane (CCM) for a fuel cell, including an electrolyte membrane and a catalyst layer formed on at least one surface of the electrolyte membrane, a membrane and electrode assembly (MEA) for a fuel cell, including the CCM, a method of preparing the MEA, and a fuel cell including the MEA. The CCM is formed directly on the electrolyte membrane.

### CROSS-REFERENCE TO RELATED APPLICATION

This application claims the benefit of Korean Patent Application No. 10-2011-001550, filed on Jan. 6, 2011 in the Korean Intellectual Property Office, the disclosure of which is incorporated herein in its entirety by reference.

### BACKGROUND

1. Field

Aspects of the present disclosure relate to catalyst coated membranes (CCMs) for fuel cells, membrane and electrode assemblies (MEAs) including the CCMs, methods of manufacturing MEAs, and fuel cells including the MEAs.

2. Description of the Related Art

Fuel cells are future clean energy sources to be used as alternatives to fossil fuels, have high output energy density and high energy conversion efficiency, and are widely used in various portable electronic devices including emission-free vehicles, household power generation systems, mobile communication equipment, medical devices, military equipment, and space equipment.

A fuel cell includes a cathode, an anode, and an electrolyte membrane interposed between the cathode and the anode. A fuel gas is supplied to the anode and oxygen is supplied to the cathode, the fuel gas at the anode is oxidized and the oxygen at the cathode is reduced, thereby generating a flow of electrons, that is, thereby generating electricity, heat and water molecules.

Each of the cathode and anode of the fuel cell includes a gas diffusion layer incorporating a carbon support, a microporous layer formed of carbon black and polytetrafluoroethylene, and a catalyst layer. However, if the cathode or the anode includes the microporous layer formed of carbon black and polytetrafluoroethylene, conductivity characteristics thereof are unsatisfactory.

### SUMMARY

Aspects of the present invention provide catalyst coated membranes (CCMs) that have high proton conductivity and are used in fuel cells, membrane and electrode assemblies (MEAs) including the CCMs, methods of manufacturing MEAs, and fuel cells including the MEAs.

According to an aspect of the present invention, a catalyst coated membrane for a fuel cell includes; an electrolyte membrane; and a catalyst layer formed on at least one surface of the electrolyte membrane.

According to another aspect of the present invention, a membrane and electrode assembly (MEA) for a fuel cell includes: the catalyst coated membrane described above; and an electrode support attached to the catalyst layer of the catalyst coated membrane.

According to another aspect of the present invention, a method of manufacturing a membrane and electrode assembly for a fuel cell includes: coating a composition for forming a catalyst layer comprising a catalyst, water, a phosphoric acid-based material, and a binder on an electrolyte membrane and drying the composition, thereby forming a catalyst coated membrane comprising a catalyst layer; and attaching an electrode support to the catalyst layer of the catalyst coated membrane.

According to another aspect of the present invention, a fuel cell includes the membrane and electrode assembly described above.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a diagram for explaining a method of manufacturing a membrane and electrode assembly (MEA) according to an embodiment of the present invention;

FIG. 2 is a diagram of a stack structure of an MEA according to an embodiment of the present invention;

FIGS. 3A through 3D are scanning electron microscope (SEM) images of cross-sections of an electrolyte membrane and a cathode catalyst layer in a catalyst coated membrane (CCM) manufactured according to Example 1, and surfaces of the electrolyte membrane and a cathode support after the cathode support is separated from the electrolyte membrane of the CCM;

FIGS. 4A through 4D are SEM images of cross-sections of an electrolyte membrane and a cathode catalyst layer formed according to Comparative Example 1 after a cathode support is separated from the electrolyte membrane, a surface of the electrolyte membrane, and surfaces of a gas diffusion layer before and after the cathode support is separated from the electrolyte membrane;

FIG. 5 is a graph of cell resistance of MEAs of fuel cells manufactured according to Example 1 and Comparative Example 1;

FIG. 6 shows cyclic-voltammetry curves of fuel cells manufactured according to Example 1 and Comparative Example 1; and

FIG. 7 is a graph of cell voltage with respect to current density of fuel cells manufactured according to Example 1 and Comparative Examples 1 and 2.

### DETAILED DESCRIPTION

Reference will now be made in detail to the present embodiments of the present invention, examples of which are illustrated in the accompanying drawings, wherein like reference numerals refer to like elements throughout. The embodiments are described below, by referring to the figures, in order to explain the present invention.

A catalyst coated membrane (CCM) for a fuel cell according to an embodiment of the present invention includes an electrolyte membrane, and a catalyst layer formed on a surface of the electrolyte membrane.

The term “formed” used herein refers to cases in which the catalyst layer is coated or laminated on the electrolyte membrane by using a coating method that is known in the art, for example, coating using a doctor blade, bar coating, or screen printing. The coating of the catalyst layer on the electrolyte membrane refers to direct coating of the catalyst layer on the electrolyte membrane without an intermediate layer present or coating of the catalyst layer on an intermediate layer formed on the electrolyte membrane.

The electrolyte membrane may be a phosphoric acid-based material doped electrolyte membrane.

The catalyst layer may include a catalyst, a binder, a phosphoric acid-based material, and water.

The amount of the phosphoric acid-based material contained in the catalyst layer may be about 0.1 to about 4 parts by weight, for example, about 0.5 to about 3 parts by weight, based on 1 part by weight of the catalyst. If the amount of the phosphoric acid-based material is within the range described above, the catalyst may sufficiently contact the phosphoric acid and, thus, performance of an electrode may be improved.

The amount of water contained in the catalyst layer may be about 1 to about 5 parts by weight, for example, about 2.5 to about 3.5 parts by weight, based on 1 part by weight of the catalyst. If the amount of water contained in the catalyst layer is within the range described above, coating with the materials that constitute the catalyst layer may be smoothly performed.

Examples of the phosphoric acid-based material are polyphosphoric acid, phosphonic acid (H₃PO₃), orthophosphoric acid (H₃PO₄), pyrophosphoric acid (H₄P₂0₇), triphosphoric acid (H₅P₃O₁₀), metaphosphoric acid, and derivatives thereof. The concentration of the phosphoric acid-based material may be 80 wt. %, 90 wt. %, 95 wt. %, or 98 wt. %.

The catalyst may be platinum (Pt) alone, or an alloy or mixture of platinum (Pt) and at least one metal selected from the group consisting of gold, palladium, rhodium, iridium, ruthenium, tin, molybdenum, cobalt, and chromium. Also, the materials may be supported by a carbonaceous support for use as a catalyst.

The binder may include at least one material selected from the group consisting of poly(vinylidenefluoride), polytetrafluoroethylene, tetrafluoroethylene-hexafluoropropylene copolymer, polyurethane, and an oxazine-based monomer.

The amount of the binder may be about 0.001 to about 0.5 parts by weight, for example, about 0.01 to about 0.2 parts by weight, based on 1 part by weight of the catalyst. If the amount of the binder is within the range described above, the wetting state of the electrode may be improved.

An oxazine-based monomer as the binder may include at least one monomer selected from the group consisting of compounds represented by Formulae 3 through 8 below:

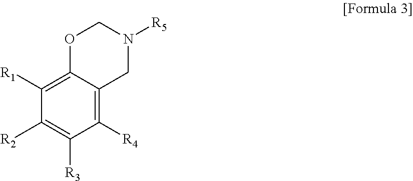

where in Formula 3, R₁, R₂, R₃, and R₄ are each independently hydrogen, a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C2-C20 heteroaryl group, a substituted or unsubstituted C2-C20 heteroaryloxy group, a substituted or unsubstituted C4-C20 carbon ring group, a substituted or unsubstituted C4-C20 carbon ring oxy group, a substituted or unsubstituted C2-C20 heteroring group, a halogen atom, a hydroxy group, or a cyano group, and

R₅ is a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 arylalkyl group, a substituted or unsubstituted C2-C20 heteroaryl group, a substituted or unsubstituted C2-C20 heteroaryloxy group, a substituted or unsubstituted C2-C20 heteroarylalkyl group, a substituted or unsubstituted C4-C20 carbon ring group, a substituted or unsubstituted C4-C20 carbon ring alkyl group, a substituted or unsubstituted C2-C20 heteroring group, or a substituted or unsubstituted C2-C20 heteroring alkyl group;

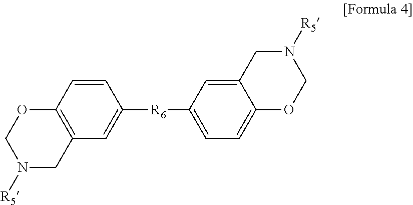

where in Formula 4, R₅′ is a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 arylalkyl group, a substituted or unsubstituted C2-C20 heteroaryl group, a substituted or unsubstituted C2-C20 heteroaryloxy group, a substituted or unsubstituted C2-C20 heteroarylalkyl group, a substituted or unsubstituted C4-C20 carbon ring group, a substituted or unsubstituted C4-C20 carbon ring alkyl group, a substituted or unsubstituted C2-C20 heteroring group, or a substituted or unsubstituted O₂-020 heteroring alkyl group, and

R₆ is a substituted or unsubstituted C1-C20 alkylene group, a substituted or unsubstituted C2-C20 alkenylene group, a substituted or unsubstituted C2-C20 alkynylene group, a substituted or unsubstituted C6-C20 arylene group, a substituted or unsubstituted C2-C20 heteroarylene group, —C(═O)—, or —SO₂—;

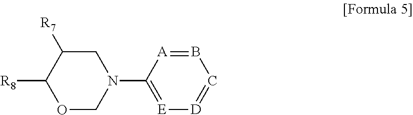

where in Formula 5, A, B, C, D, and E are all carbon, or one or more selected from the group consisting of A, B, C, D, and E are nitrogen (N), and the other elements are carbon (C), and

R₇ and R₉ are connected to each other to form a ring, wherein the ring is a C6-C10 carbon ring group, a C3-C10 heteroaryl group, a fused C3-C10 heteroaryl group, a C3-C10 heteroring group, or a fused C3-C10 heteroring group;

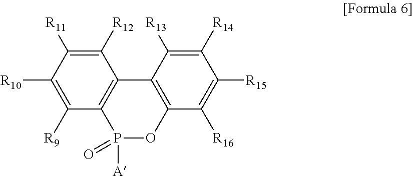

where in Formula 6, A′ is a substituted or unsubstituted C1-C20 heteroring group, a substituted or unsubstituted C4-C20 cyclo alkyl group, or a substituted or unsubstituted C1-C20 alkyl group, and

R₉ through R₁₆ are each independently hydrogen, a C1-C20 alkyl group, a C1-C20 alkoxy group, a C6-C20 aryl group, a C6-C20 aryloxy group, a C1-C20 heteroaryl group, a C1-C20 heteroaryloxy group, a C4-C20 cyclo alkyl group, a C1-C20 heteroring group, a halogen atom, a cyano group, or a hydroxy group;

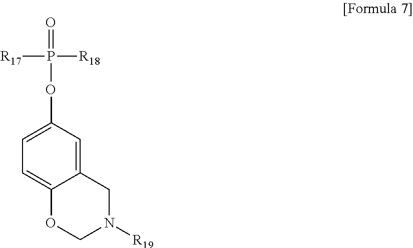

where in Formula 7, R₁₇ and R₁₈ are each independently a C1-C20 alkyl group, a C1-C20 alkoxy group, a C6-C20 aryl group, a C6-C20 aryloxy group, or a group represented by Formula 7A below:

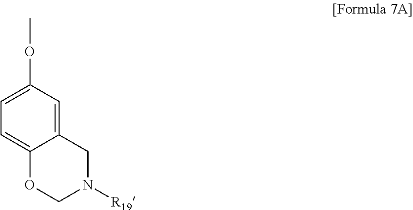

where in Formulae 7 and 7A, R₁₉ and R_{19′} are each independently hydrogen, a C1-C20 alkyl group, a C1-C20 alkoxy group, a C6-C20 aryl group, a C6-C20 aryloxy group, a halogenated C6-C20 aryl group, a halogenated C6-C20 aryloxy group, a C1-C20 heteroaryl group, a C1-C20 heteroaryloxy group, a halogenated C1-C20 heteroaryl group, a halogenated C1-C20 heteroaryloxy group, a C4-C20 carbon ring group, a halogenated C4-C20 carbon ring group, a C1-C20 heteroring group, or a halogenated C1-C20 heteroring group;

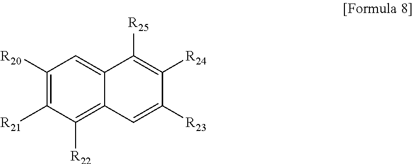

where in Formula 8, neighboring two or more groups selected from R₂₀, R₂₁, and R₂₂ are connected to each other to form a group represented by Formula 8A below, and

the remaining unselected groups are each independently hydrogen, a C1-C20 alkyl group, a C1-C20 alkoxy group, a C6-C20 aryl group, a C6-C20 aryloxy group, a halogenated C6-C20 aryl group, a halogenated C6-C20 aryloxy group, a C1-C20 heteroaryl group, a C1-C20 heteroaryloxy group, a halogenated C1-C20 heteroaryl group, a halogenated C1-C20 heteroaryloxy group, a C4-C20 carbon ring group, a halogenated C4-C20 carbon ring group, a C1-C20 heteroring group, or a halogenated C1-C20 heteroring group, and

neighboring two or more groups selected from R₂₃, R₂₄ and R₂₅ are connected to each other to form a group represented by Formula 8A, and the remaining unselected groups are each independently a C1-C20 alkyl group, a C1-C20 alkoxy group, a C6-C20 aryl group, a C6-C20 aryloxy group, a halogenated 06-020 aryl group, a halogenated C6-C20 aryloxy group, a C1-C20 heteroaryl group, a C1-C20 heteroaryloxy group, a halogenated C1-C20 heteroaryl group, a halogenated C1-C20 heteroaryloxy group, a C4-C20 carbon ring group, a halogenated C4-C20 carbon ring group, a C1-C20 heteroring group, or a halogenated C1-C20 heteroring group; and

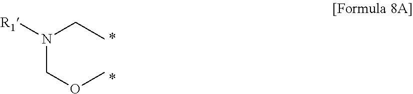

where in Formula 8A, R₁′ is a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C20 aryl group, a substituted or unsubstituted C6-C20 aryloxy group, a substituted or unsubstituted C7-C20 arylalkyl group, a substituted or unsubstituted C2-C20 heteroaryl group, a substituted or unsubstituted C2-C20 heteroaryloxy group, a substituted or unsubstituted C2-C20 heteroarylalkyl group, a substituted or unsubstituted C4-C20 carbon ring group, a substituted or unsubstituted C4-C20 carbon ring alkyl group, a substituted or unsubstituted C2-C20 heteroring group, or a substituted or unsubstituted C2-C20 heteroring alkyl group, and

* refers to sites respectively connected to the neighboring two or more groups selected from R₂₀, R₂₁, and R₂₂ and the neighboring two or more groups selected from R₂₀, R₂₁, and R₂₂ in Formula 8.

In Formula 8A, R₁′ is any one of the groups represented by Formula 8B below:

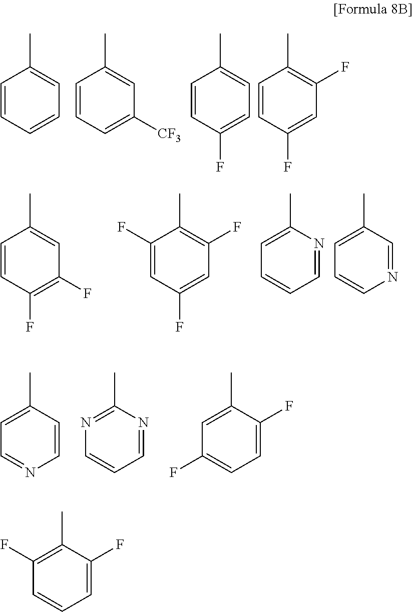

The compound represented by Formula 3 may be a compound selected from the group consisting of compounds represented by Formulae 9 through 57 below:

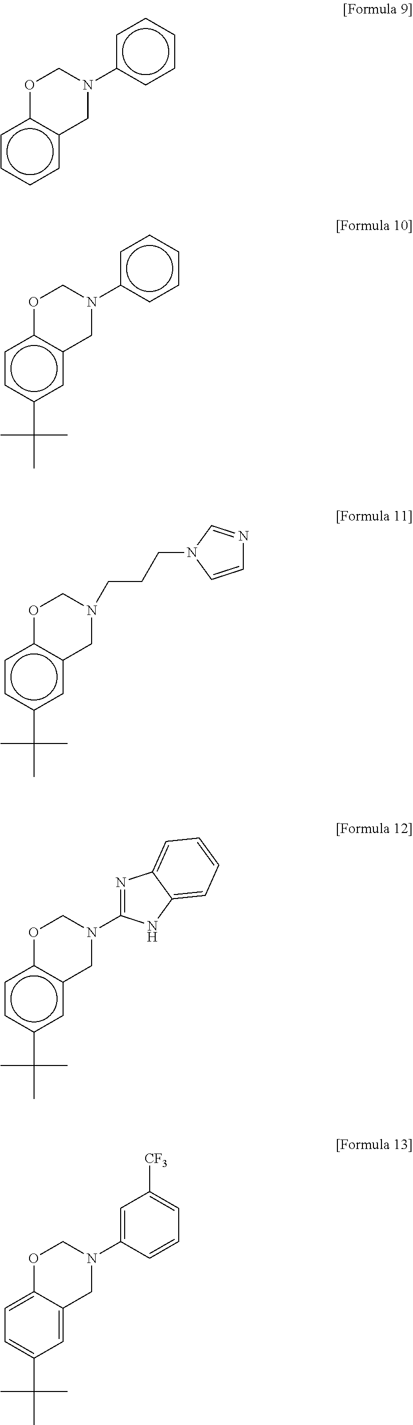

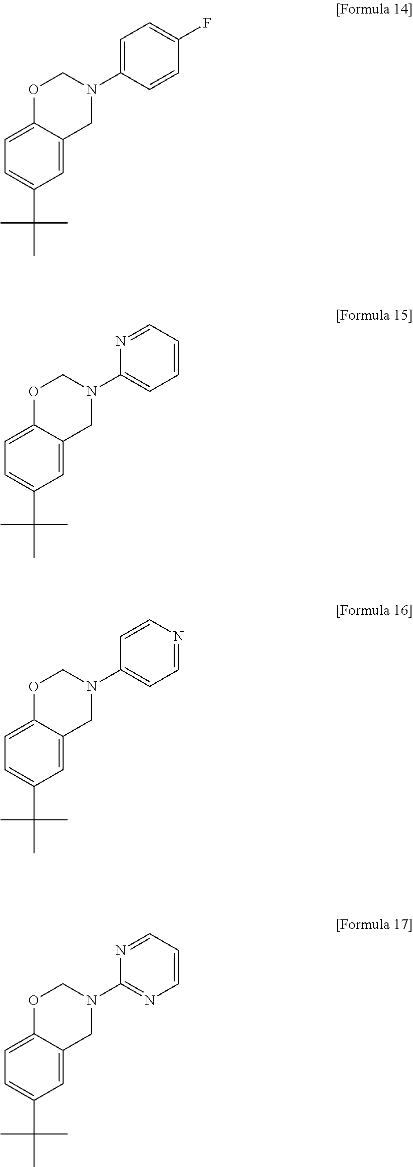

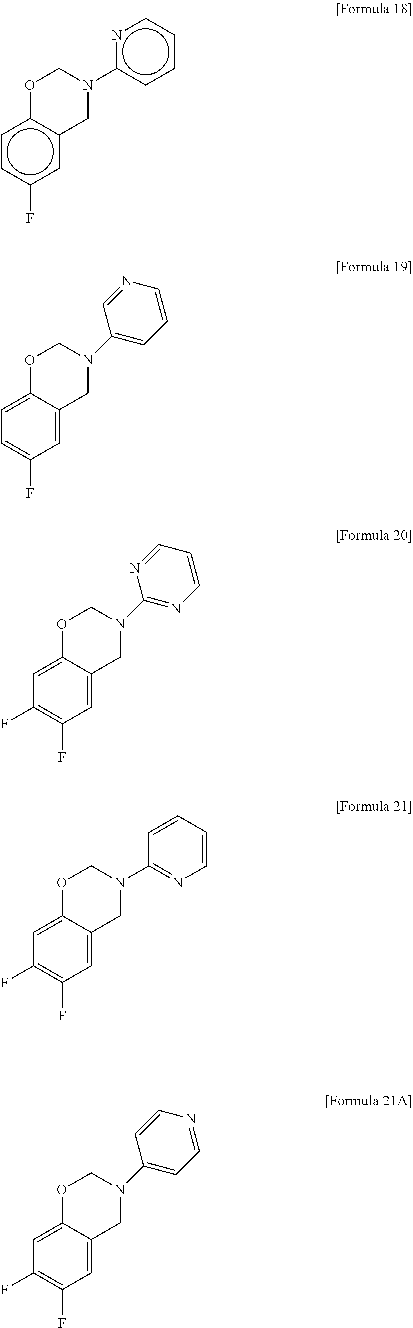

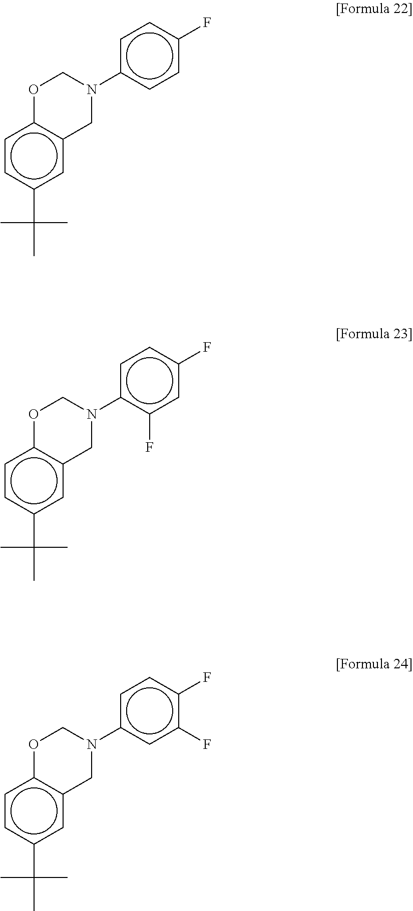

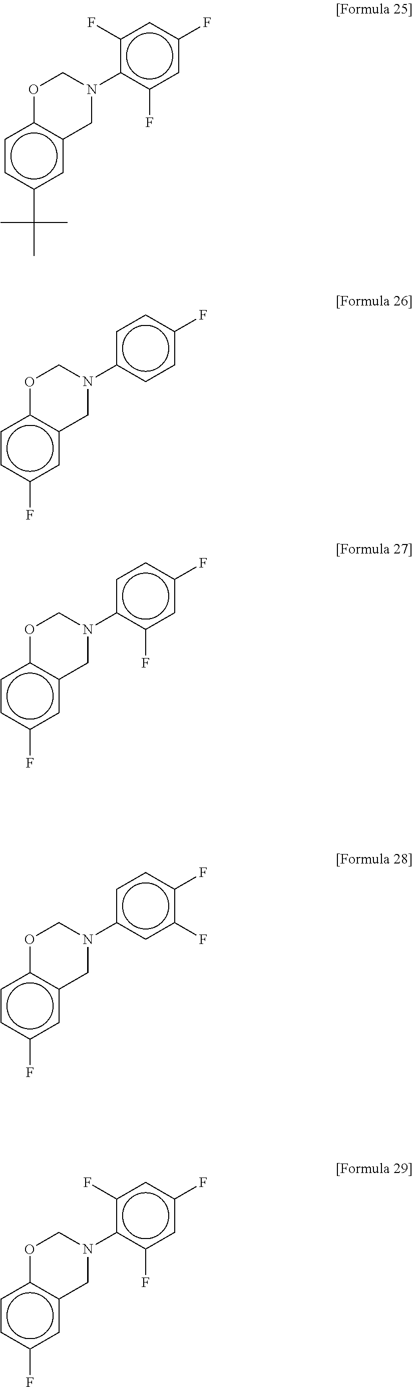

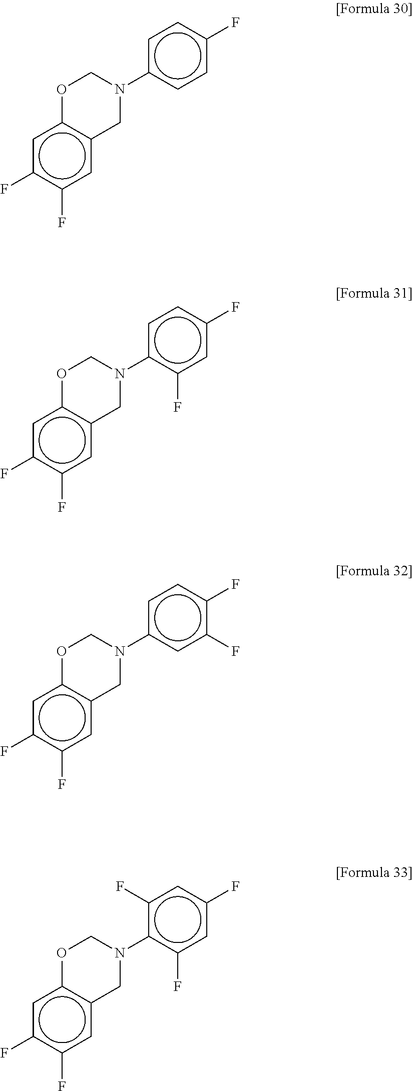

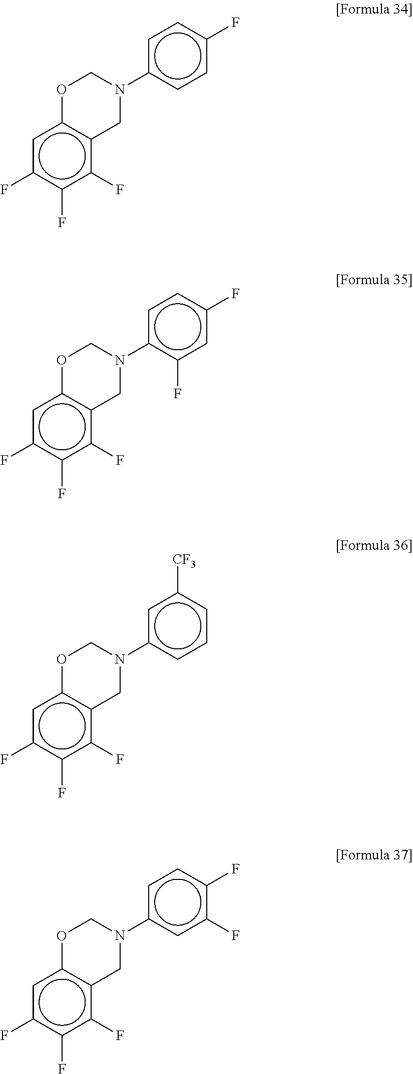

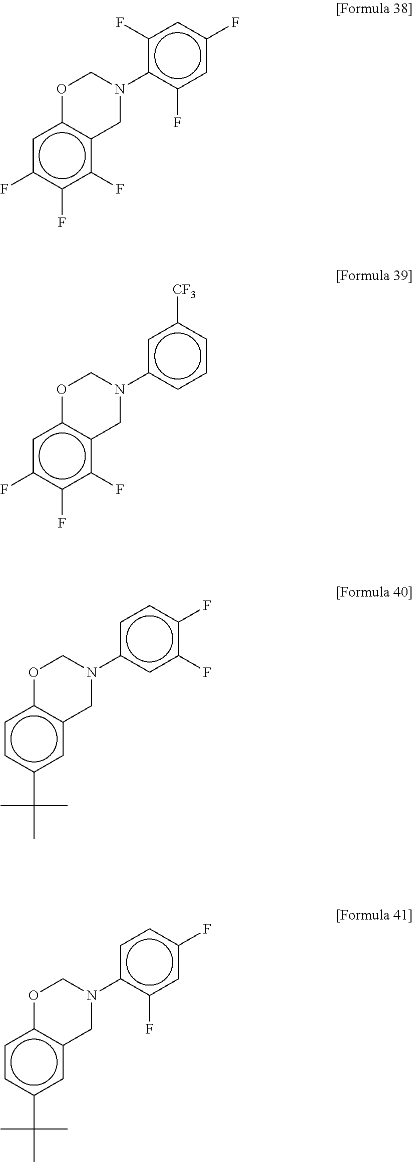

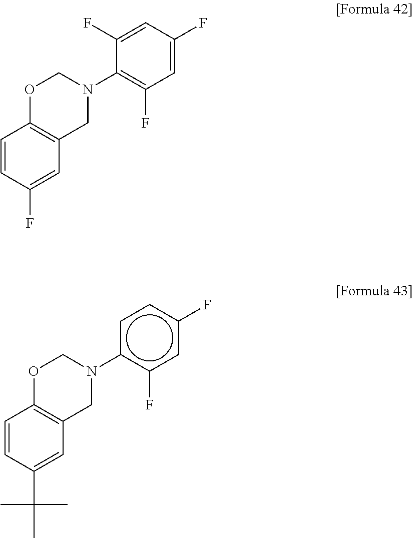

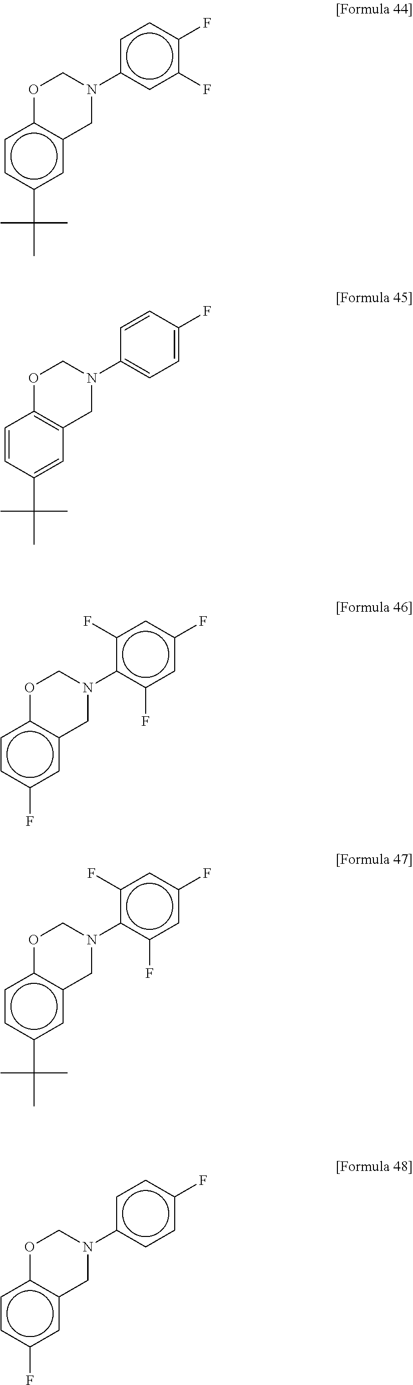

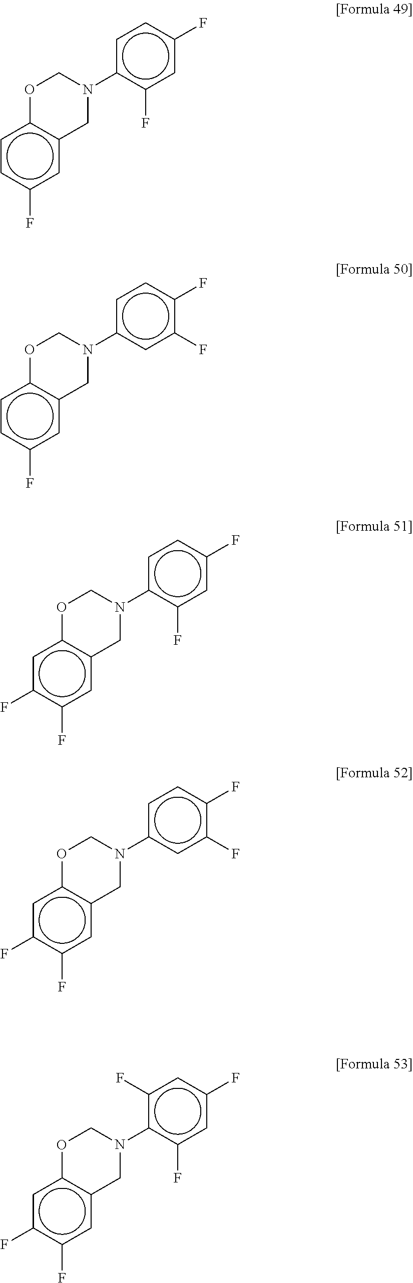

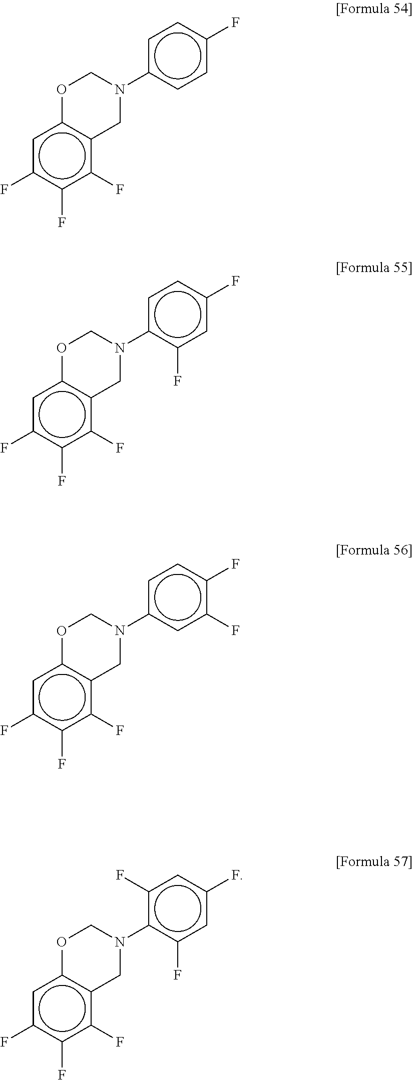

The compound represented by Formula 4 may be one where the compound is selected from the group consisting of compounds represented by Formulae 58 to 62 below:

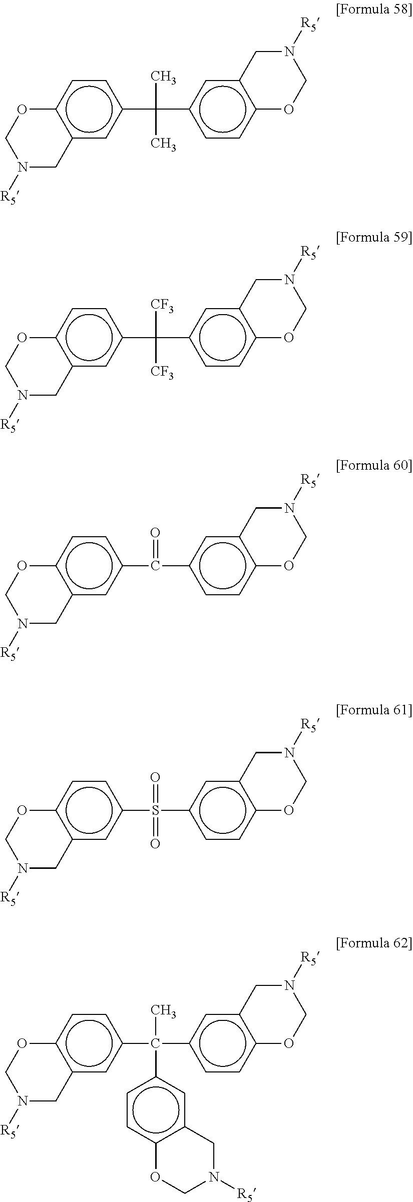

where in Formulae 58 through 62, R′₅ is —CH₂—CH═CH₂, or one where the substituent is selected from the group consisting of substituents represented by Formula 63 below:

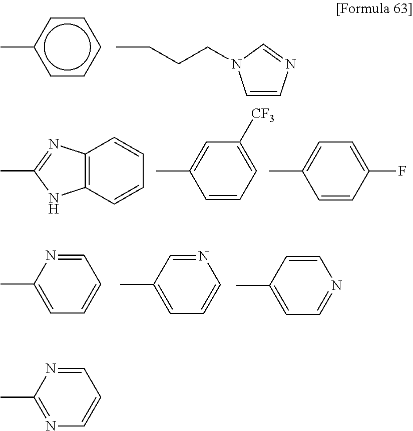

The compound represented by Formula 8 may be one where the compound is selected from the group consisting of compounds represented by Formulae 64A (HF-a) through 67 below:

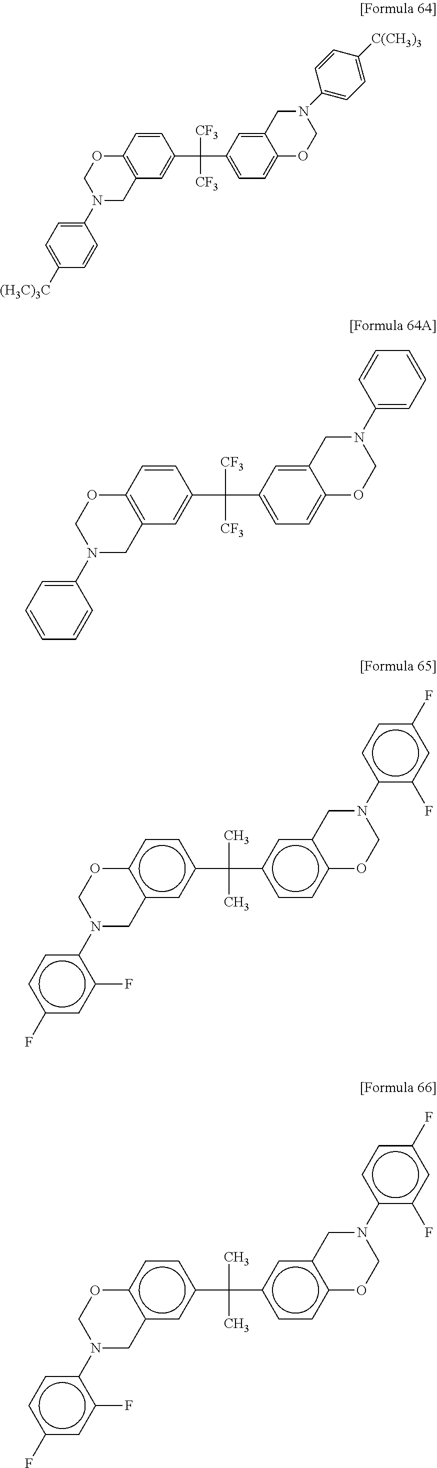

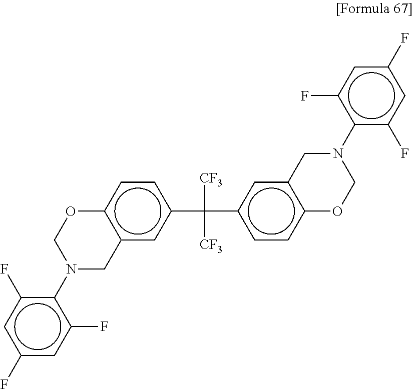

The compound represented by Formula 5 may be one where the compound is selected from the group consisting of compounds represented by Formulae 68 to 71 below:

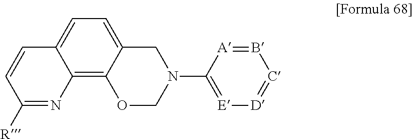

where in Formula 68, R″ is hydrogen or a C1-C10 alkyl group,

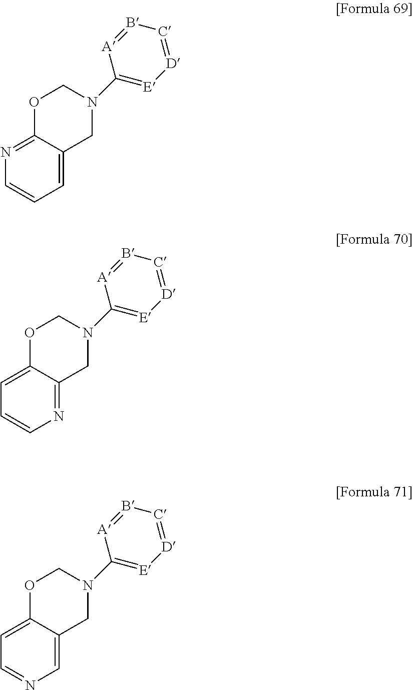

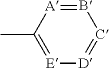

where in Formulae 68 through 71, may be one where the substituent is selected from the group consisting of substituents represented by Formula 72 below:

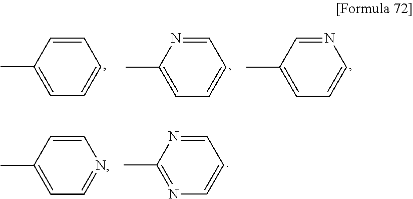

The compound represented by Formula 5 may be one where the compound is selected from the group consisting of compounds represented by Formulae 73 through 94 below:

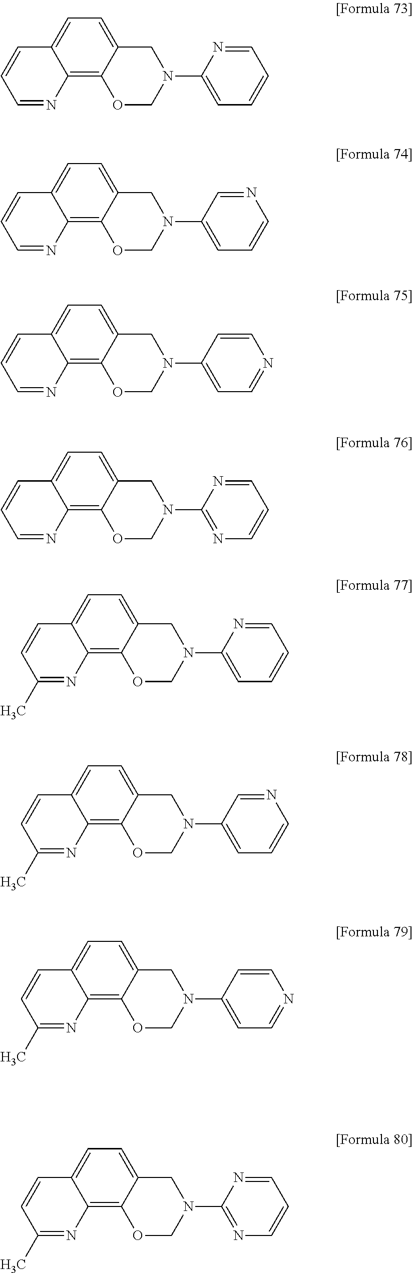

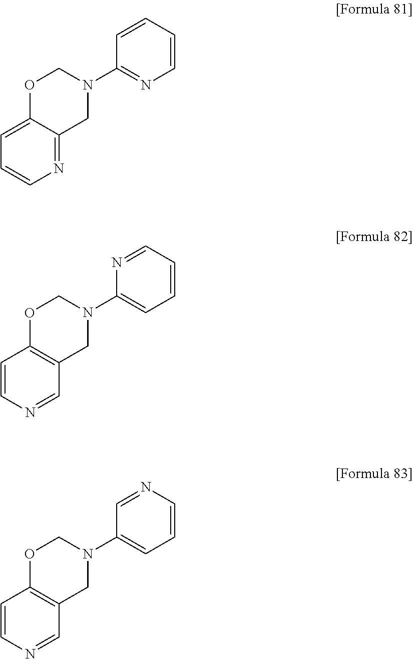

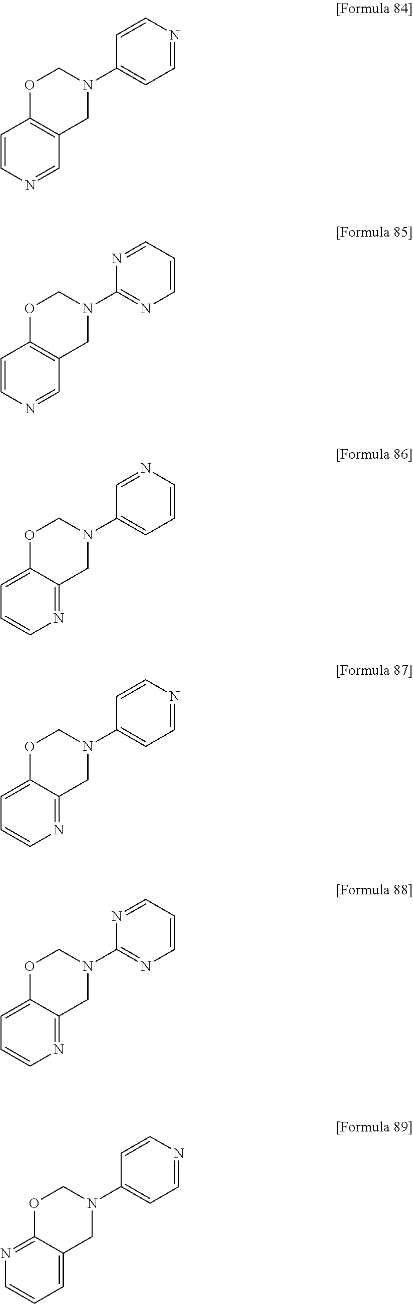

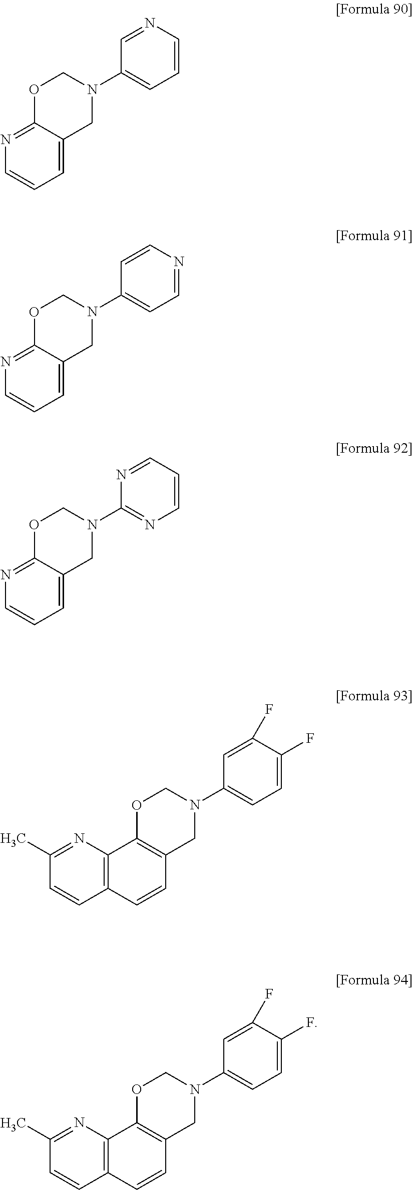

In Formula 6, A′ may be one where the substituent is selected from the group consisting of substituents represented by Formulae 95 and 96 below:

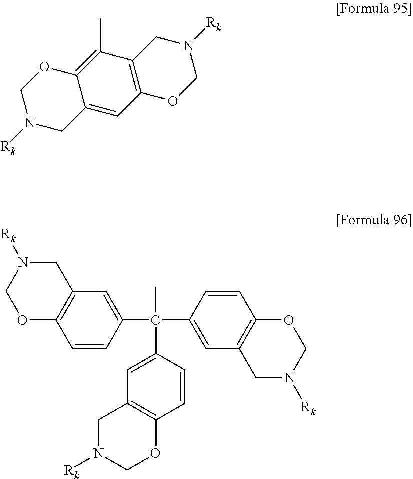

where in Formulae 95 and 96, Rₖ is hydrogen, a C1-C20 alkyl group, a C1-C20 alkoxy group, a C6-C20 aryl group, a C6-C20 aryloxy group, a halogenated C6-C20 aryl group, a halogenated C6-C20 aryloxy group, a C1-C20 heteroaryl group, a C1-C20 heteroaryloxy group, a halogenated C1-C20 heteroaryl group, a halogenated C1-C20 heteroaryloxy group, a C4-C20 carbon ring group, a halogenated C4-C20 carbon ring group, a C1-C20 heteroring group, or a halogenated C1-C20 heteroring group.

The compound represented by Formula 6 may be one where the compound is selected from the group consisting of compounds represented by Formulae 97 or 98 below:

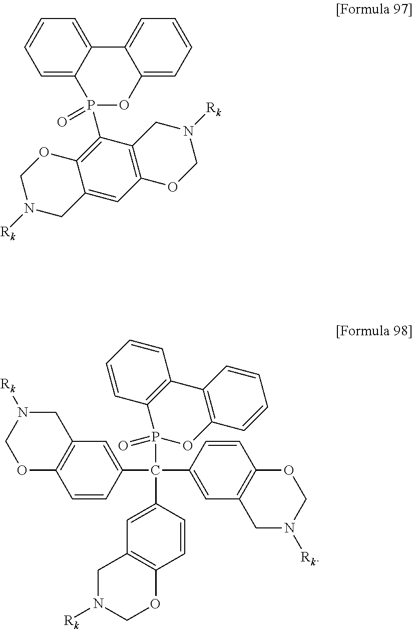

where in Formulae 97 and 98. Rₖ is one where the substituent is selected from the group consisting of substituents represented by Formula 99 below:

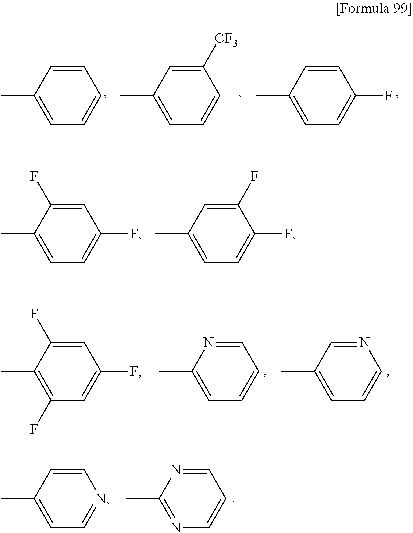

The compound represented by Formula 6 may be one where the compound is selected from the group consisting of compounds represented by Formulae 100 through 105 below:

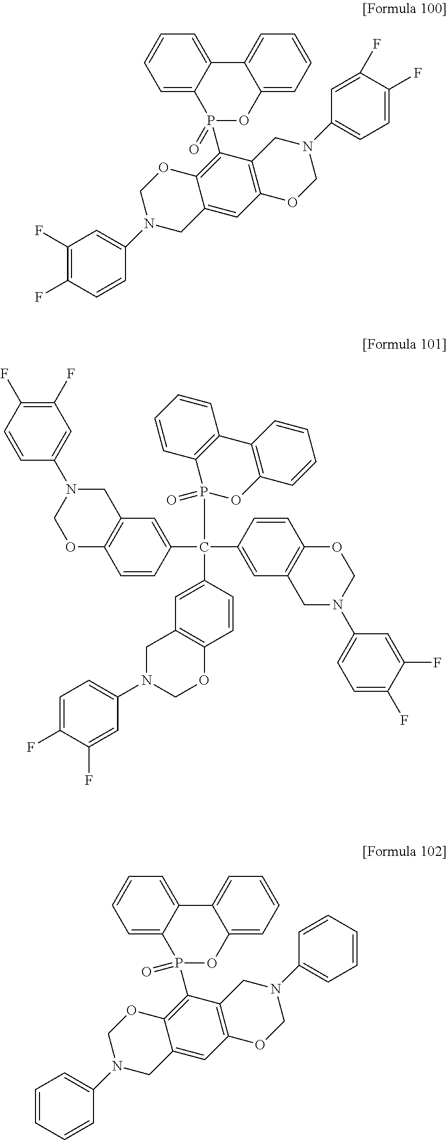

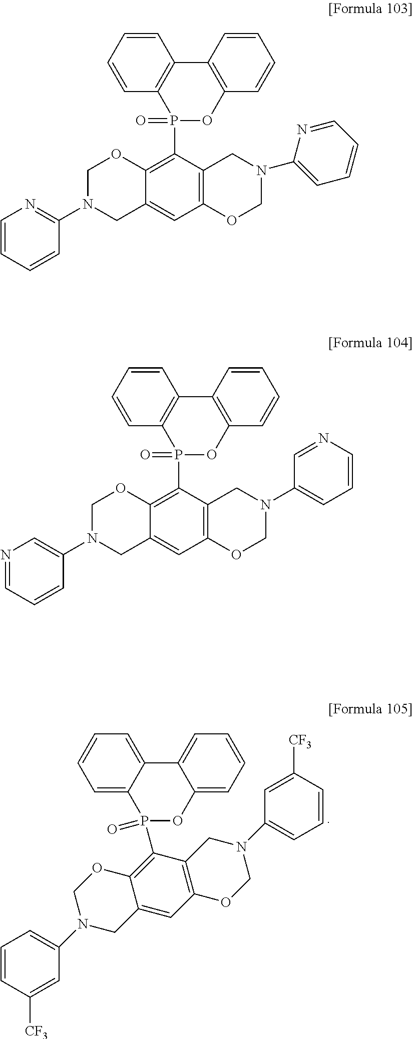

The compound represented by Formula 7 may be one where the compound is selected from the group consisting of compounds represented by Formulae 106 and 107:

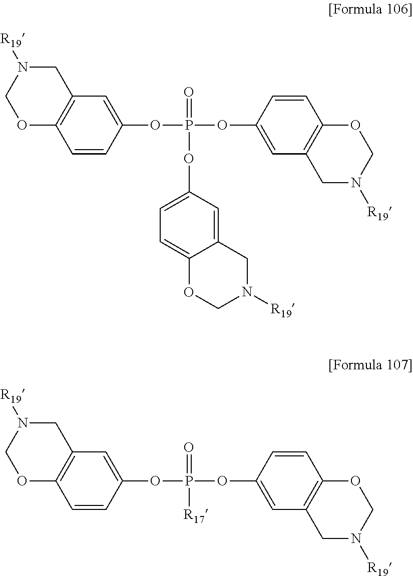

where in Formulae 106 and 107. R₁₇′ is a C1-C10 alkyl group, a C1-C10 alkoxy group, a C6-C10 aryl group, or a C6-C10 aryloxy group, and

R₁₉′ is a substituent selected from the group consisting of substituents represented by Formulae 108 to 110 below:

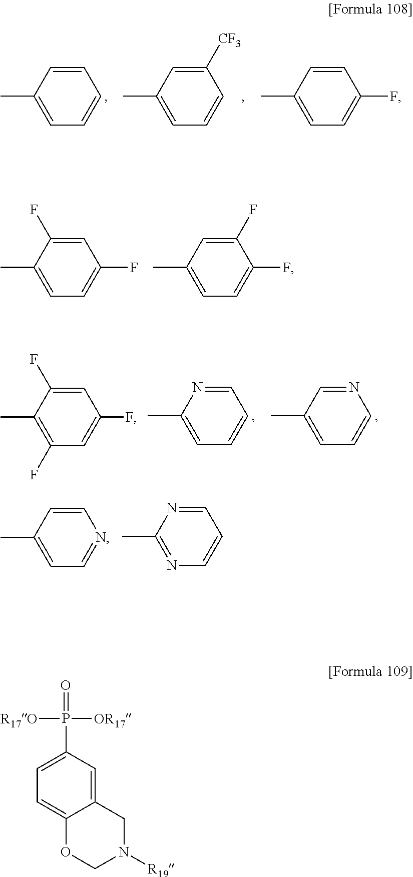

where in Formula 109, R₁₇″ is a C6-C10 aryl group, and

R₁₉″ is where the substituent is selected from the group consisting of substituents represented by Formula 110 below:

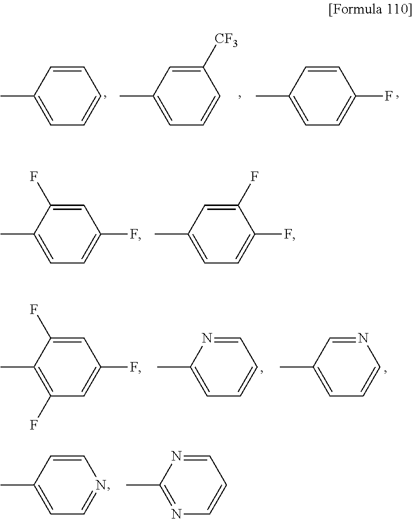

The compound represented by Formula 7 may be one where the compound is selected from the group consisting of compounds represented by Formulae 111 through 117 below:

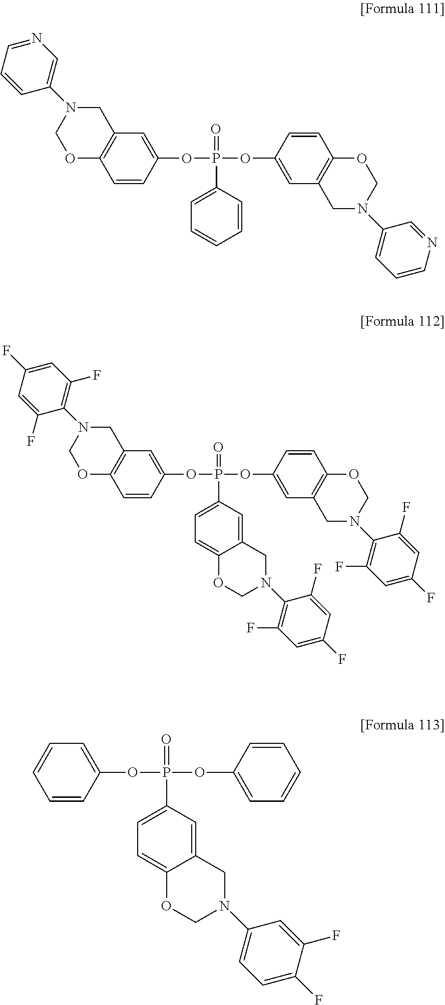

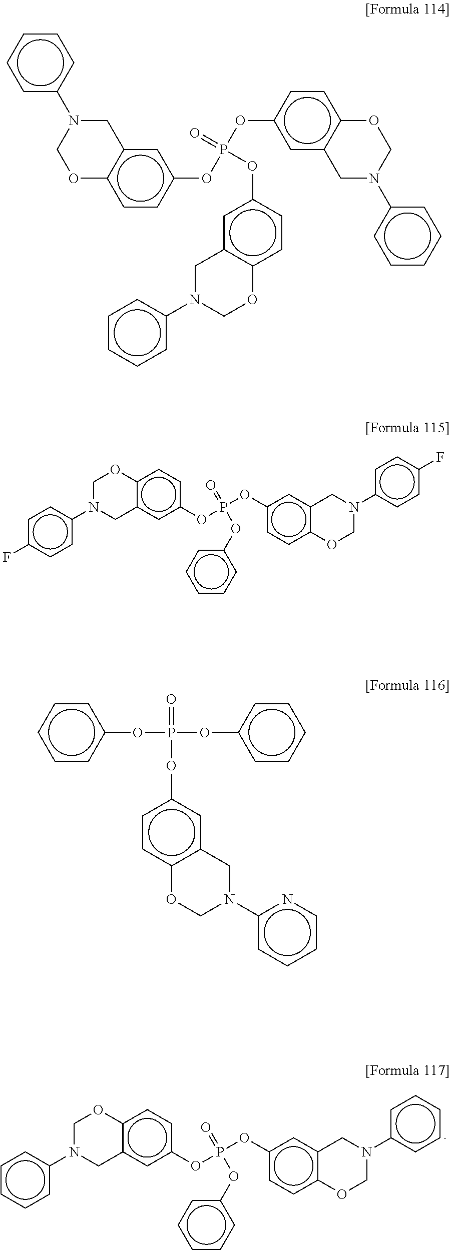

Examples of the compound represented by Formula 8 are compounds represented by Formulae 118 through 120 below:

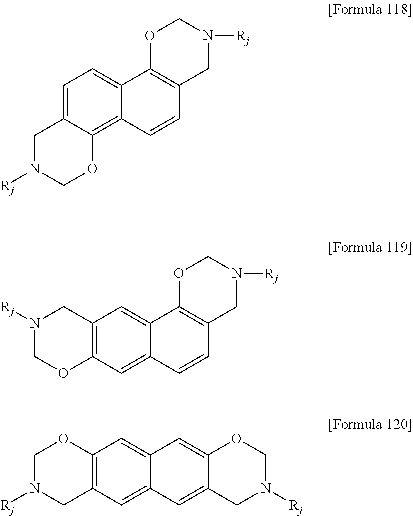

where in Formulae 118 through 120. Rⱼ is a substituent selected from the group consisting of substituents represented by Formula 121 below:

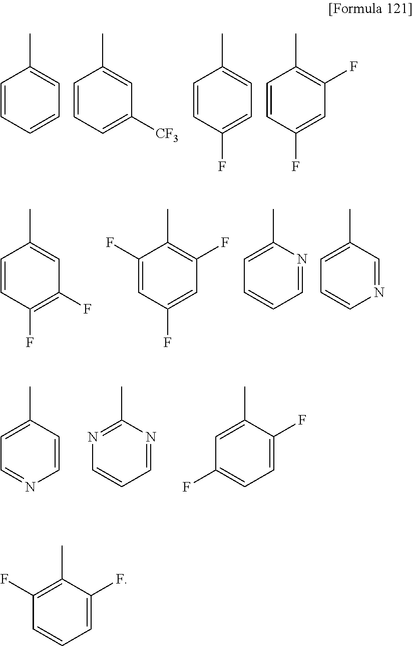

Examples of the compound represented by Formula 8 are compounds represented by Formulae 122 through 129 below:

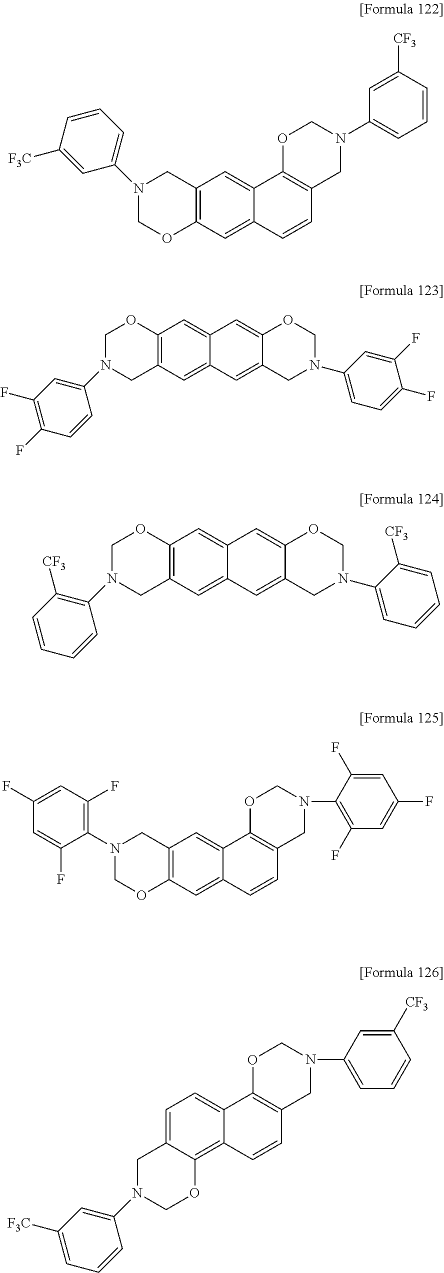

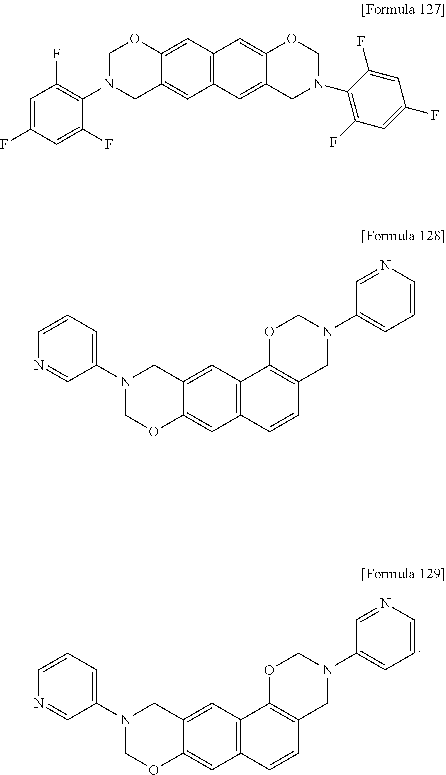

Examples of an oxazine-based monomer according to an embodiment of the present invention are a compound represented by Formula 18 (4FPh2AP), a compound represented by Formula 21 (3,4DFPh2AP), a compound represented by Formula 64A (HF-a), and a compound represented by Formula 82 (3HP2AP):

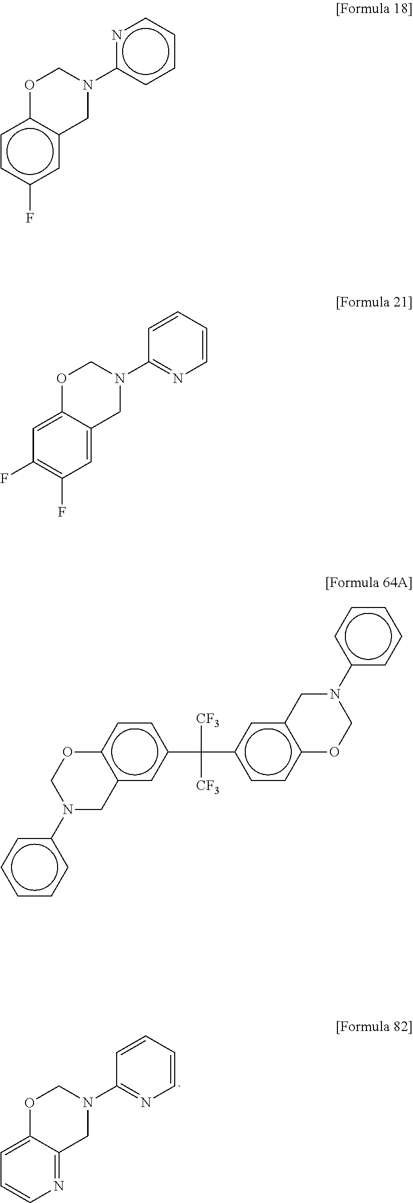

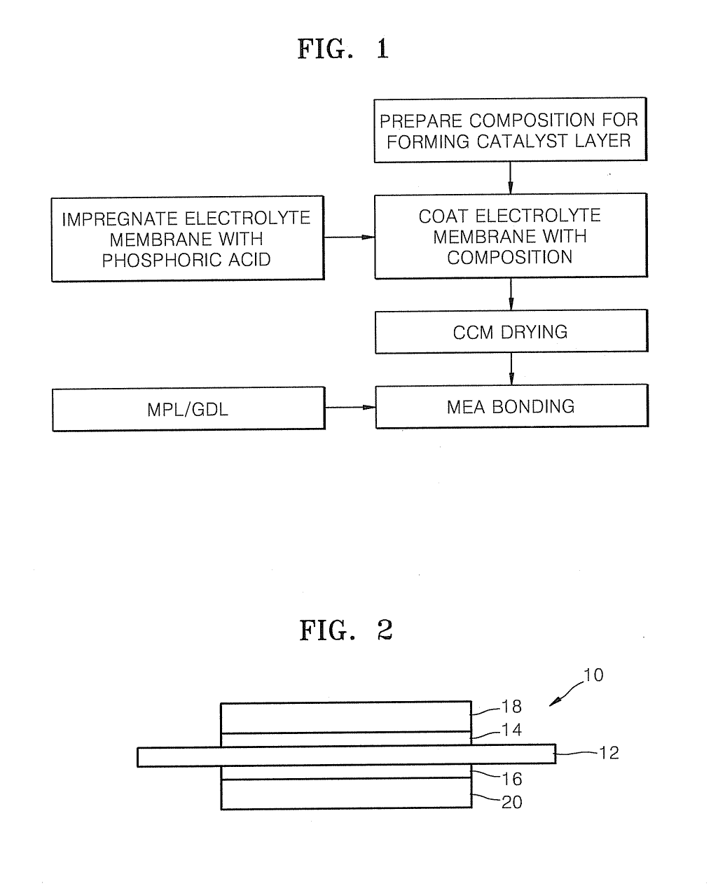

Hereinafter, a method of preparing the CCM for a fuel cell will be described in detail with reference to FIG. 1. First, a composition for forming a catalyst layer is prepared by mixing the catalyst, the phosphoric acid-based material, water, and the binder.

The composition may be directly coated on an electrolyte membrane.

The electrolyte membrane may be a phosphoric acid-based material doped membrane. The doping concentration of the phosphoric acid-based material may be about 100 to about 800 parts by weight based on 100 parts by weight of the electrolyte membrane. If the doping concentration of the phosphoric acid-based material is within the range described above, when the CCM bonds to a gas diffusion layer (GDL), the phosphoric acid permeates into the catalyst layer so that activity of the catalyst and performance of an electrode are maintained.

The amount of the phosphoric acid-based material in the composition may be about 0.1 to about 4 parts by weight, for example, about 0.5 to about 3 parts by weight based on 1 part by weight of the catalyst. The amount of water in the composition may be about 1 to about 5 parts by weight based on 1 part by weight of the catalyst, and the amount of the binder may be about 0.01 to about 0.2 parts by weight based on 1 part by weight of the catalyst.

The coated product is dried to complete formation of the CCM. The drying may be performed at a temperature of about 0 to about 80° C., for example, about 40 to about 80° C. For example, the drying may be performed at a temperature of about 60° C.

The CCM prepared as described above may include a catalyst layer having a planar surface, and the interfacial resistance between the electrolyte membrane and the catalyst layer is very small. Also, the utilization ratio of the catalyst in the catalyst layer may be increased.

The thickness deviation of the catalyst layer may be 20% or less, for example, about 0.5 to about 20%. If the thickness deviation of the catalyst layer is within the range described above, the catalyst layer has a uniform surface and thus the interfacial resistance between the electrolyte membrane and the catalyst layer is reduced.

The thickness deviation of the catalyst layer is evaluated by using scanning electron microscopy (SEM) as follows: an average thickness of portions of the catalyst layer excluding the thickest portion and the thinnest portion is measured and the degree of deviation is derived from the average thickness.

The thickness of the electrolyte membrane may be about 10 to about 100 μm, for example, about 40 to about 80 μm, and the thickness of the catalyst layer is about 20 to about 100 μm, for example, about 40 to about 60 μm.

The thickness ratio of the electrolyte membrane to the catalyst layer is about 1:1 to about 1:2, for example, 1:1. If the thickness ratio of the electrolyte membrane to the catalyst layer is as described above, the utilization ratio of the catalyst in the CCM and proton conductivity characteristics of an electrode may be improved.

The utilization ratio of the catalyst of the catalyst layer may be 40% or more, for example, about 50 to about 90%. For example, the utilization ratio of the catalyst of the catalyst layer may be about 60 to about 90%. If the utilization ratio of the catalyst is within the ranges described above, proton conductivity characteristics of an electrode are excellent.

The utilization ratio of the catalyst may be evaluated using Equation 1:

Catalyst utilization ratio (%)=effective catalyst area/entire catalyst area=hydrogen absorbed and desorbed area/(loading amount of electrode catalyst specific surface area of catalyst). [Equation 1]

Regarding the CCM, the electrolyte membrane contains the phosphoric acid-based material, the interfacial resistance between the electrolyte membrane and the catalyst layer is decreased, and the electrolyte membrane has excellent proton conductivity characteristics.

An electrode support is deposited on the catalyst layer of the CCM and the resultant structure is pressed and assembled to attach the electrode support to the catalyst layer, thereby forming an electrode and membrane assembly (MEA).

The pressing may be performed at a temperature of about 0 to about 150° C., for example, about 20 to about 130° C., and at a pressure of about 0.01 to about 0.15 tonf/cm², for about 0.5 minutes to about 3 minutes. If the pressing and assembling are performed in the conditions described above, the MEA has excellent performance, for example, high current density.

The electrode support may include a gas diffusion layer, and a microporous layer including a conductive material and a binder.

The gas diffusion layer may include carbon paper or carbon cloth.

The conductive material included in the microporous layer may include at least one carbonaceous material selected from the group consisting of active carbon powder, active carbon fiber, carbon black, carbon aerosol, carbon nanotube, carbon nanofiber, carbon nanohorn powder, natural graphite powder, and synthesized graphite powder.

The binder for use in the electrode support may include at least one selected from the group consisting of polytetrafluoroethylene, a tetrafluoroethylene-perfluoroalkylvinylether copolymer, and a tetrafluoroethylene-hexafluoropropylene copolymer, which are fluorine-based polymers for supplying hydrophilic properties.

Cell resistance of the MEA may be smaller than that of a conventional catalyst coated electrode (CCE) in which a catalyst layer is coated on an electrode support. For example, the cell resistance of the MEA according to the present embodiment may be about 50 to about 200 mΩ*cm².

The amount of the catalyst on the electrolyte membrane after the electrode support is separated from the electrolyte membrane may be about 45 to about 100 parts by weight, for example, about 45 to about 60 parts by weight, based on 100 parts by weight of the total weight of the catalyst in the catalyst layer before the electrode support is separated from the electrolyte membrane.

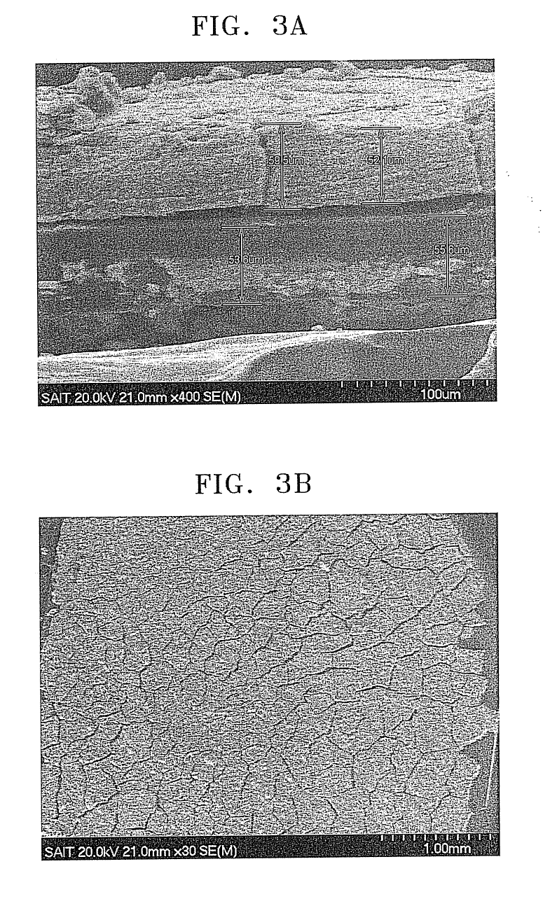

FIG. 2 is a diagram of a stack structure of an MEA 10 according to an embodiment of the present invention. In the MEA 10, a catalyst layer is formed on at least one surface of the electrolyte membrane 12. For example, a catalyst layer 14 is formed on a surface of the electrolyte membrane 12 and a catalyst layer 16 is formed on another surface of the electrolyte membrane 12. In the MEA 10, at least one of the catalyst layer 14 and the catalyst layer 16 may be directly coated on the electrolyte membrane 12.

Meanwhile, in an MEA formed by using a conventional CCE method, a catalyst layer is disposed near the electrolyte membrane and only pressed with a predetermined pressure. That is, the catalyst layer is not directly coated on the electrolyte membrane. Accordingly, the binding force between the electrolyte membrane 12 and the catalyst layers 14 and 16 of the present embodiment is higher than that between the electrolyte membrane and the catalyst layer which are formed according to a conventional CCE method.

According to a conventional CCE method, a catalyst layer is formed on carbon paper as a support. Thus, the surface state of the catalyst layer is greatly dependent upon the surface state of the carbon paper as a support However, according to an embodiment of the present invention, the catalyst layer 14 or 16 is formed on the electrolyte membrane 12 and thus, the surface state of the catalyst layer 14 or 16 is greatly dependent upon the surface state of the electrolyte membrane 12. Since the surface state of the electrolyte membrane 12 is more even than carbon paper, the surface of the catalyst layer 14 or 16 according to this embodiment of the present invention is more even than the surface of the catalyst layer prepared according to the conventional CCE method.

The catalyst layer 14 or 16 coated on the electrolyte membrane 12 is not limited, and may be any cathode catalyst layer.

Electrode supports 18 and 20 are respectively attached to the catalyst layers 14 and 16. Although not illustrated in FIG. 2, each of the electrode supports 18 and 20 includes a gas diffusion layer and a microporous layer.

The electrode supports 18 and 20 may be formed as follows. A composition for forming a microporous layer is prepared by mixing a conductive material, a solvent, and a fluorine-based polymer.

The amount of the fluorine-based polymer may be about 3 to about 17 parts by weight based on 100 parts by weight of the conductive material. The solvent may include at least one selected from the group consisting of isopropyl alcohol, water, ethanol, and methanol. The amount of the solvent may be about 150 to about 200 parts by weight based on 100 parts by weight of the conductive material.

Subsequently, the composition is coated on a gas diffusion layer and heat-treated to form a microporous layer, thereby completing manufacturing of an electrode support 18 or 20.

The coating method may not be limited and may be, for example, spin coating, dip coating, or screen printing. The heat treatment may be performed at a temperature of about 320 to about 350° C. If the heat treatment temperature is within the range described above, the electrode support has excellent fuel supply and discharge characteristics.

The electrolyte membrane 12 may be any of various electrolyte membranes that are commercially used in fuel cells. Examples of the electrolyte membrane 12 are a polybenzimidazole electrolyte membrane, a polybenzooxazine-polybenzimidazole copolymer electrolyte membrane, and a polytetrafluoroethylene (PTFE) porous membrane. Alternatively, the electrolyte membrane 12 may be an electrolyte membrane using a polymerization product of at least one of the oxazine-based monomers represented by Formulae 3 through 8.

The electrolyte membrane may be further impregnated with a phosphoric acid-based material. Examples of the phosphoric acid-based material are polyphosphoric acid, phosphonic acid (H₃PO₃), orthophosphoric acid (H₃PO₄), pyrophosphoric acid (H₄P₂O₇), triphosphoric acid (H₅P₃O₁₀), metaphosphoric acid, and a derivative thereof. The concentration of the phosphoric acid-based material may be at least 80 wt. %, 90 wt. %, 95 wt. %, or 98 wt. %.

An electrolyte membrane using a polymerization product of an oxazine-based monomer is manufactured by using a method disclosed in US Patent Application Publication 2009/0117436. For example, the electrolyte membrane may be manufactured using at least one compound selected from the group consisting of a compound represented by Formula 64 (tBuPh-a), a compound represented by Formula 64A (HF-a), and a compound represented by Formula 114 (PPO).

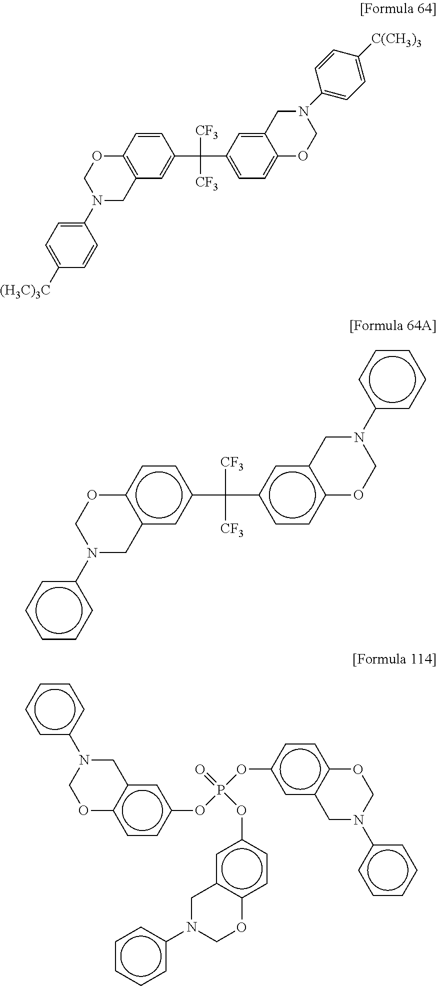

A fuel cell according to an embodiment of the present invention is manufactured by placing the MEA in a fuel cell case and air and fuel are supplied to the case. Then, the fuel cell is operated. The operating temperature of the fuel cell may be, for example, about 150 to about 180° C.

The fuel cell including the MEA has high thermal stability at high temperature, and high voltage performance with respect to current density. Such a fuel cell is useful in high-temperature and un-humidified conditions.

Substituents in the formulae above may be defined as follows.

As used herein, the term “alkyl” refers to a fully saturated branched or unbranched (or straight chain or linear) hydrocarbon moiety.

Examples of the alkyl group used herein include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, and n-heptyl.

At least one hydrogen atom of the alkyl group may be substituted with a halogen atom, a C1-C20 alkyl group substituted with a halogen atom (for example, CCF₃, CHCF₂, CH₂F and CCl₃), a C₁-C₂₀ alkoxy, a C2-C20 alkoxyalkyl, a hydroxy group, a nitro group, a cyano group, an amino group, an amidino group, a hydrazine, a hydrazone, a carboxyl group or a salt thereof, a sulfonyl group, a sulfamoyl, a sulfonic acid group or a salt thereof, a phosphoric acid or a salt thereof, a C1-C20 alkyl group, a C2-C20 alkenyl group, a C2-C20 alkynyl group, a C1-C20 heteroalkyl group, a C6-C20 aryl group, a C6-C20 arylalkyl group, a C6-C20 heteroaryl group, a C7-C20 heteroarylalkyl group, a C6-C20 heteroaryloxy group, a C6-C20 heteroaryloxyalkyl group, or a C6-C20 heteroarylalkyl group.

As used herein, the term “halogen atom” refers to fluoro, bromo, chloro, or iodo.

As used herein, the term “a C1-C20 alkyl group substituted with a halogen atom” refers to a C1-C20 alkyl group that is substituted with one or more halo groups, and unlimited examples of a C1-C20 alkyl group that is substituted with one or more halo groups are monohaloalkyl, dihaloalkyl, and polyhaloalkyl including perhaloalkyl.

A monohaloalkyl has one iodo, bromo, chloro or fluoro within the alkyl group, and dihaloalky and polyhaloalkyl groups have two or more of the same halo atoms or a combination of different halo groups within the alkyl.

As used herein, the term “alkoxy” refers to alkyl-O—, wherein alkyl is defined herein above. Examples of alkoxy include, but are not limited to, methoxy, ethoxy, propoxy, 2-propoxy, butoxy, tert-butoxy, pentyloxy, hexyloxy, cyclopropyloxy-, cyclohexyloxy- and the like. At least one hydrogen atom of the alkoxy group may be substituted with the same substituent as described above in connection with the alkyl group.

The term “alkoxyalkyl” refers to an alkyl group, as defined above, in which the alkyl group is substituted with alkoxy. At least one hydrogen atom of the alkoxyalkyl group may be substituted with the same substituent as described above in connection with the alkyl group. The term alkoxyalkyl includes a substituted alkoxyalkyl moiety.

The term “alkenyl” refers to a branched or unbranched hydrocarbon having at least one carbon-carbon double bond. Examples of an alkenyl group are, but are not limited to, vinyl, allyl, butenyl, isopropenyl or isobutenyl. At least one hydrogen atom of the alkenyl group may be substituted with one of the same substituents as described above in connection with the alkyl group.

The term “alkynyl” refers to a branched or unbranched hydrocarbon having at least one carbon-carbon triple bond. Examples of an alkynyl group are, but are not limited to, ethynyl, butynyl, isobutynyl or isopropynyl.

At least one hydrogen atom of the alkynyl group may be substituted with one of the same substituents as described above in connection with the alkyl group.

The term “aryl” is used alone or in combination, and refers to an aromatic hydrocarbon group having one or more rings.

The term “aryl” also refers to a group in which an aromatic ring is fused to one or more cycloalkyl rings.

Examples of aryl are, but are not limited to, phenyl, naphthyl, or tetrahydronaphthyl.

At least one hydrogen atom of an aryl group may be substituted with one of the same substituents as described above in connection with the alkyl group.

The term “arylalkyl” is an alkyl substituted with aryl. Examples of arylalkyl are benzyl or Phenyl-CH₂CH₂—.

The term “aryloxy” includes an —O-aryl, wherein aryl is defined herein. Examples of aryloxy are phenoxy and the like. At least one hydrogen atom of an aryloxy group may be substituted with one of the same substituents as described above in connection with the alkyl group.

The term “heteroaryl” refers to a monocyclic or bicyclic organic compound that contains one or more hetero atoms selected from N, O, P, and S, and the remaining ring atoms are carbon atoms. The heteroaryl may include, for example, 1 to 5 hetero atoms, and 5 to 10 ring members.

S or N may be oxidized to various oxidation states.

Typical monocyclic heteroaryl groups include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isooxazol-3-yl, isooxazol-4-yl, isooxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2yl, pyrazin-4-yl, pyrazin-5-yl, 2-pyrimidin-2-yl, 4-pyrimidin-2-yl, and 5-pyrimidin-2-yl.

The term “heteroaryl” also refer to a group in which a heteroaromatic ring is fused to one or more aryl, cycloaliphatic, or heterocyclic rings.

Examples of bicyclic heteroaryl are indolyl, isoindolyl, indazolyl, indolizinyl, purinyl, quinolizinyl, quinolinyl, isoquinolinyl, cinnolinyl, phthalazinyl, naphthyridinyl, quinazolinyl, quinaxalinyl, phenanthridinyl, phenathrolinyl, phenazinyl, phenothiazinyl, phenoxazinyl, benzisoqinolinyl, thieno[2,3-b]furanyl, furo[3,2-b]-pyranyl, 5H-pyrido[2,3-d]-o-oxazinyl, 1H-pyrazolo[4,3-d]-oxazolyl, 4H-imidazo[4,5-d]thiazolyl, pyrazino[2,3-d]pyridazinyl, imidazo[2,1-b]thiazolyl, imidazo[1,2-b][1,2,4]triazinyl, 7-benzo[b]thienyl, benzoxazolyl, benzimidazolyl, benzothiazolyl, benzoxapinyl, benzoxazinyl, 1H-pyrrolo[1,2-b][2]benzazapinyl, benzofuryl, benzothiophenyl, benzotriazolyl, pyrrolo[2,3-b]pyridinyl, pyrrolo[3,2-c]pyridinyl, pyrrolo[3,2-b]pyridinyl, imidazo[4,5-b]pyridinyl, imidazo[4,5-c]pyridinyl, pyrazolo[4,3-d]pyridinyl, pyrazolo[4,3-c]pyridinyl, pyrazolo[3,4-c]pyridinyl, pyrazolo[3,4-d]pyridinyl, pyrazolo[3,4-b]pyridinyl, imidazo[1,2-a]pyridinyl, pyrazolo[1,5-a]pyridinyl, pyrrolo[1,2-b]pyridazinyl, imidazo[1,2-c]pyrimidinyl, pyrido[3,2-d]pyrimidinyl, pyrido[4,3-d]pyrimidinyl, pyrido[3,4-d]pyrimidinyl, pyrido[2,3-d]pyrimidinyl, pyrido[2,3-b]pyrazinyl, pyrido[3,4-b]pyrazinyl, pyrimido[5,4-d]pyrimidinyl, pyrazino[2,3-b]pyrazinyl, and pyrimido[4,5-d]pyrimidinyl.

At least one hydrogen atom in the heteroaryl group may be substituted with one of the same substituents as described above in connection with the alkyl group.

The term “heteroarylakyl” refers to alkyl substituted with heteroaryl.

The term “heteroaryloxy” includes an —O-heteroaryl moiety. At least one hydrogen atom in heteroaryloxy may be substituted with one of the same substituents as described above in connection with the alkyl group.

The term “heteraryloxyalkyl” refers to an alkyl group that is substituted with heteroaryloxy. At least one hydrogen atom in a heteraryloxyalkyl group may be substituted with one of the same substituents as described above in connection with the alkyl group.

As used herein, the term “carbocyclic” refers to saturated or partially unsaturated but non-aromatic monocyclic, bicyclic or tricyclic hydrocarbon groups.

Exemplary monocyclic hydrocarbon groups include cyclopentyl, cyclopentenyl, cyclohexyl and cyclohexenyl.

Exemplary bicyclic hydrocarbon groups include bornyl, decahydronaphthyl, bicyclo[2.1.1]hexyl, bicyclo[2.2.1]heptyl, bicyclo[2.2.1]heptenyl, and bicyclo[2.2.2]octyl.

Exemplary tricyclic hydrocarbon groups include adamantyl.

At least one hydrogen atom in a carbocyclic group may be substituted with one of the same substituents as described above in connection with the alkyl group.

The term “heterocyclic” refers to a ring containing 5-10 ring atoms including a hetero atom such as N, S, P, or O, and an example of a heterocyclic group is pyridyl. At least one hydrogen atom in a heterocyclic group may be substituted with one of the same substituents as described above in connection with the alkyl group.

The term “heterocyclicoxy” includes an —O-heterocyclic, and at least one hydrogen atom in a heterocyclicoxy group may be substituted with one of the same substituents as described above in connection with the alkyl group.

The term “sulfonyl” includes R″—SO₂—, wherein R″ is hydrogen, alkyl, aryl, heteroaryl, aryl-alkyl, heteroaryl-alkyl, alkoxy, aryloxy, cycloalkyl, or heterocyclic.

The term “sulfamoyl” includes H₂NS(O)₂—, alkyl-NHS(O)₂—, (alkyl)₂NS(O)₂—, aryl-NHS(O)₂—, alkyl(aryl)-NS(O)₂—, (aryl)₂NS(O)₂—, heteroaryl-NHS(O)₂—, (aryl-alkyl)-NHS(O)₂—, or (heteroaryl-alkyl)-NHS(O)₂—. At least one hydrogen atom in a sulfamoyl group may be substituted with one of the same substituents as described above in connection with the alkyl group.

The term “amino” includes compounds wherein a nitrogen atom is covalently bonded to at least one carbon or heteroatom. The term “amino” also includes —NH₂ and also includes substituted moieties.

The term also includes “alkylamino” wherein the nitrogen is bound to at least one additional alkyl group. The term also includes “arylamino” and “diarylamino” groups wherein the nitrogen is bound to at least one or two independently selected aryl groups, respectively.

The term “alkylene”, “alkenylene”, “alkynylene”, “arylene”, and “heteroarylene” are defined as described above, except that “alkyl”, “alkenyl”, “alkynyl”, “aryl”, and “heteroaryl”, which are mono-valent groups, are changed into divalent groups.

At least one hydrogen atom in “alkylene”, “alkenylene”, “alkynylene”, “arylene”, or “heteroarylene” groups may be substituted with the one of the same substituents as described above in connection with the alkyl group.

One or more embodiments will now be described in further detail with reference to the following examples. These examples are for illustrative purpose only and are not intended to limit the scope of the one or more embodiments.

### Example 1

### Manufacturing of CCM and Fuel Cell Using CCM

0.1 g of Pt as a catalyst, 0.04 g of a compound represented by Formula 21 below (3,4FPh2AP), 0.3 g of water, and 0.117 g of a phosphoric acid were mixed to prepare a composition for forming a cathode catalyst layer:

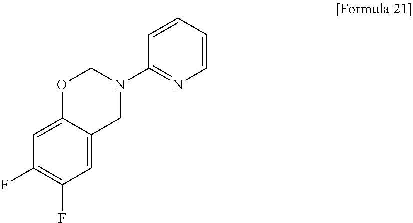

Separately, a phosphoric acid-doped electrolyte membrane was manufactured as follows.

50 parts by weight of a compound represented by Formula 114 below (PPO), and 50 parts by weight of polybenzimidazole (m-PBI) represented by Formula 130 were blended, and the mixture was cured at a temperature of about 220° C. to form an electrolyte membrane.

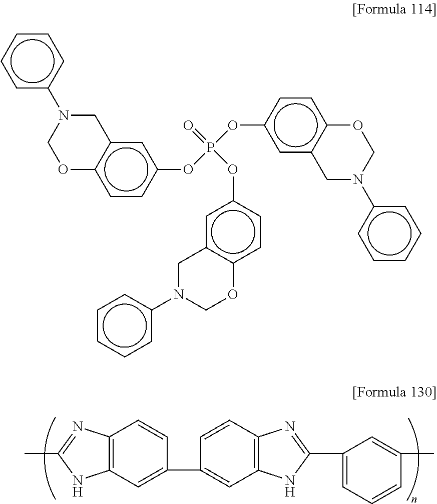

Then, the electrolyte membrane was impregnated with 85 wt. % phosphoric acid at a temperature of 80° C. for at least 4 hours to obtain a phosphoric acid-doped electrolyte membrane. In this case, the amount of the phosphoric acid was about 500 parts by weight based on 100 parts by weight of the total weight of the electrolyte membrane.

The composition was coated on the phosphoric acid-doped electrolyte membrane, and dried at a temperature of 60° C. for 10 minutes to form a cathode catalyst layer, thereby completing formation of a catalyst coated membrane (CCM) for a cathode.

A cathode support was deposited on the cathode catalyst layer of the CCM for a cathode. The cathode support was formed by coating carbon paper as a gas diffusion layer with carbon and PTFE to form a microporous layer. The amount of PTFE was 5 parts by weight based on 100 parts by weight of carbon.

Separately, regarding an anode, Pt/C as a catalyst was directly coated on an anode support and dried at a temperature of 80° C. for 1 hour, at a temperature of 120° C. for 20 minutes, and at a temperature of 150° C. for 10 minutes to form an anode catalyst layer on the anode support.

The microporous layer of the cathode support was disposed near the cathode catalyst layer of the CCM, and the anode catalyst layer was attached to the phosphoric acid-doped electrolyte membrane of the CCM. Then, a PTFE gasket was installed at each of an anode and a cathode and the resultant structure was thermally pressed at a temperature of 125° C. and at 0.1 tonf/cm² to form an MEA. Also, a fuel cell was manufactured using the MEA.

Performance of the fuel cell was evaluated while hydrogen and oxygen were supplied thereto at a temperature of 150° C. and at a constant current of 0.2 A/cm².

### Comparative Example 1

First, 0.5 g of Pt, 0.25 g of a compound represented by Formula 18 below (4FPh2AP), and 5 g of N-methylpyrrolidone were mixed to prepare a composition for forming a cathode catalyst layer.

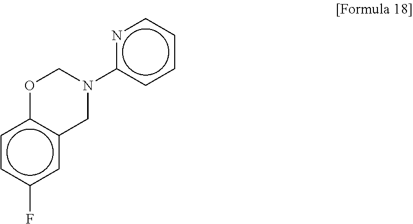

The composition was coated on a cathode support and dried at a temperature of 80° C. for 1 hour, at a temperature of 120° C. for 20 minutes, and at a temperature of 150° C. for 10 minutes to form a cathode catalyst layer on the cathode support.

The cathode support was formed by coating carbon paper as a gas diffusion layer with carbon and PTFE. The amount of PTFE was 5 parts by weight based on 100 parts by weight of carbon to form a microporous layer.

Separately, regarding an anode, Pt/C as a catalyst was directly coated on an anode support and dried at a temperature of 80° C. for 1 hour, at a temperature of 120° C. for 20 minutes, and at a temperature of 150° C. for 10 minutes to form an anode catalyst layer on the anode support.

As an electrolyte membrane, a phosphoric acid doped-electrolyte membrane prepared in the same manner as in Example 1 was used.

In this experiment, the cathode catalyst layer and the anode catalyst layer were respectively disposed near a microporous layer of the cathode support and a microporous layer of the anode support, and 20 μm of a sub gasket and 200 μm of a PTFE gasket were installed at each of an anode and a cathode, and the resultant structure was thermally pressed at a temperature of 125° C. and at a pressure of 0.1 tonf/cm² to form an MEA. Also, a fuel cell was manufactured using the MEA.

Performance of the fuel cell was evaluated while hydrogen and oxygen were supplied thereto at a temperature of 150° C. and at a constant current of 0.2 A/cm².

### Comparative Example 2

An MEA and a fuel cell were manufactured in the same manner as in Comparative Example 1, except that a cathode catalyst layer was formed without the compound represented by Formula 18 (4FPh2AP).

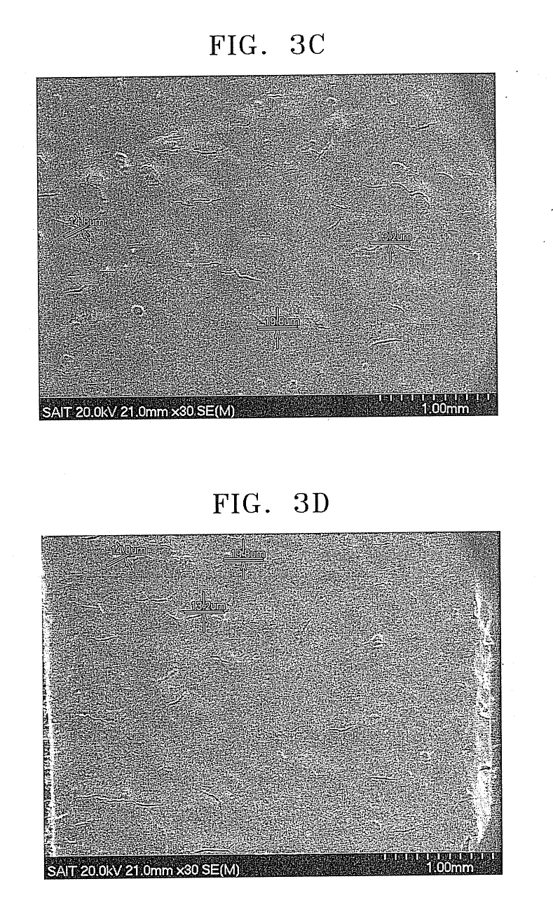

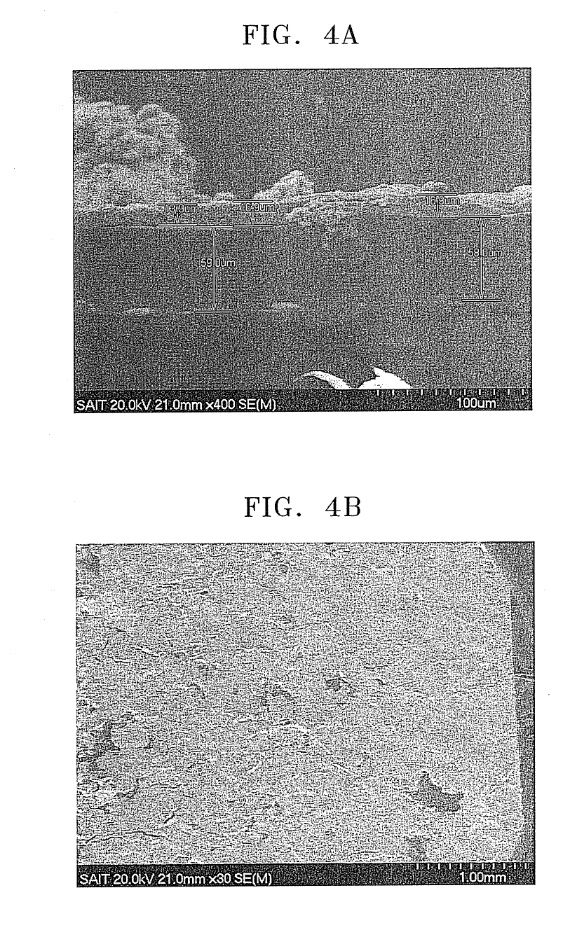

A cross-section of the cathode CCM manufactured according to Example 1 was evaluated by using SEM, and the results are shown in FIG. 3A. Also, a cross-section of the cathode catalyst layer after the cathode support was separated from the MEA manufactured according to Comparative Example 1 was evaluated by using SEM, and the results are shown in FIG. 4A.

Referring to FIGS. 3A and 4A, the cathode catalyst layer on the electrolyte membrane of the CCM manufactured according to Example 1 has a uniform thickness. On the other hand, the cathode catalyst layer of the electrolyte membrane manufactured according to Comparative Example 1 has a non-uniform thickness.

The state of the electrolyte membrane after the cathode support deposited on the cathode CCM prepared according to Example 1 was separated was evaluated by using SEM, and the results are shown in FIG. 3B. Also, a cross-section of the cathode catalyst layer of Comparative Example 1 after the cathode support was separated from the MEA prepared according to Comparative Example 1 was separated was evaluated by using SEM, and the results are shown in FIG. 4B.

Referring to FIGS. 3B and 4B, it was confirmed that regarding Comparative Example 1, when the cathode support was separated, a portion of the cathode catalyst layer was separated and, thus, remained on the electrolyte membrane, and on the electrolyte membrane of Example 1, the cathode catalyst layer remained.

The surface of the microporous layer of the cathode support of Example 1 was evaluated by using SEM before and after the gas diffusion layer was separated from the CCM of Example 1, and the results are shown in FIGS. 3C through 3D. FIG. 3C is an SEM image of the surface of the microporous layer before the gas diffusion layer was separated from the CCM, and FIG. 3D is an SEM image of the surface of the microporous layer after the gas diffusion layer was separated from the CCM.

The surface of the gas diffusion layer of the MEA of Comparative Example 1 was evaluated by using SEM before and after the gas diffusion layer was separated from the electrolyte membrane of the MEA, and the results are shown in FIGS. 4C and 4D. FIG. 4C is an SEM image of the microporous layer of the cathode support before the gas diffusion layer was separated from the electrolyte membrane, and FIG. 4D is an SEM image of the microporous layer after the cathode support was separated from the electrolyte membrane.

If the images of FIGS. 3C and 3D are compared with the images of FIGS. 4C and 4D, as shown in the SEM images of FIGS. 3C and 3D, regarding Example 1, the surface of the microporous layer almost did not change before and after the cathode support was separated from the CCM. However, the surface of the gas diffusion layer of the cathode support of the MEA of Comparative Example 1 changed.

Regarding the CCM of Example 1 and the electrolyte membrane and the cathode catalyst layer of Comparative Example 1, the thickness deviation of the catalyst layer, surface flatness, and the thickness ratio of the electrolyte membrane to the cathode catalyst layer were evaluated, and the results are shown in Table 1 below.

The thickness deviation of the catalyst layer and the thickness ratio of the cathode catalyst layer to the electrolyte membrane were evaluated by using SEM.

TABLE 1

| | Thickness deviation of | Thickness ratio of |
|---|---|---|
| | cathode catalyst layer | electrolyte membrane to |
| | (%) | cathode catalyst layer |
| Example 1 | About 20% | 1:1 |
| Comparative | About 25% | 5:1 |
| Example 1 | | |
| Comparative | About 25% | 5:1 |
| Example 2 | | |

Regarding each of the MEAs of Example 1 and Comparative Example 1, the cathode support was separated from the cathode catalyst layer, and then the amount of the catalyst remaining on the electrolyte membrane was measured.

As a result, it was found that the amount of the catalyst remaining on the electrolyte membrane of Example 1 was about 100 parts by weight based on 100 parts by weight of the total weight of the cathode catalyst in the cathode catalyst layer before the cathode support was separated from the electrolyte membrane, and the amount of the catalyst remaining on the electrolyte membrane of Comparative Example 1 was about 30 parts by weight based on 100 parts by weight of the total weight of the cathode catalyst in the catalyst layer before the cathode support was separated from the electrolyte membrane.

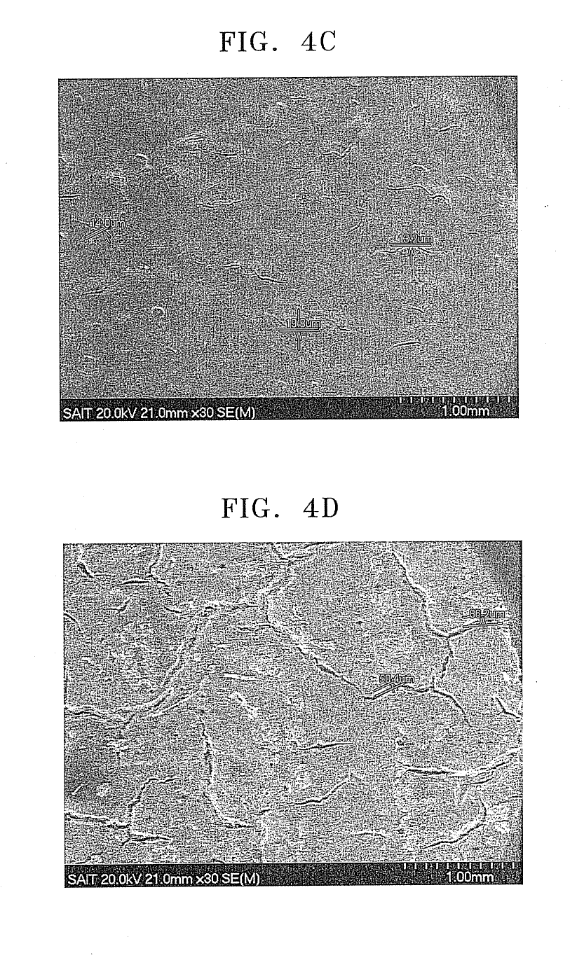

Regarding each of the fuel cells manufactured according to Example 1 and Comparative Example 1, cell resistance of the MEA was measured, and the results are shown in FIG. 5. Referring to FIG. 5, it was confirmed that the MEA of Example 1 has better cell resistance characteristics than that of Comparative Example 1.

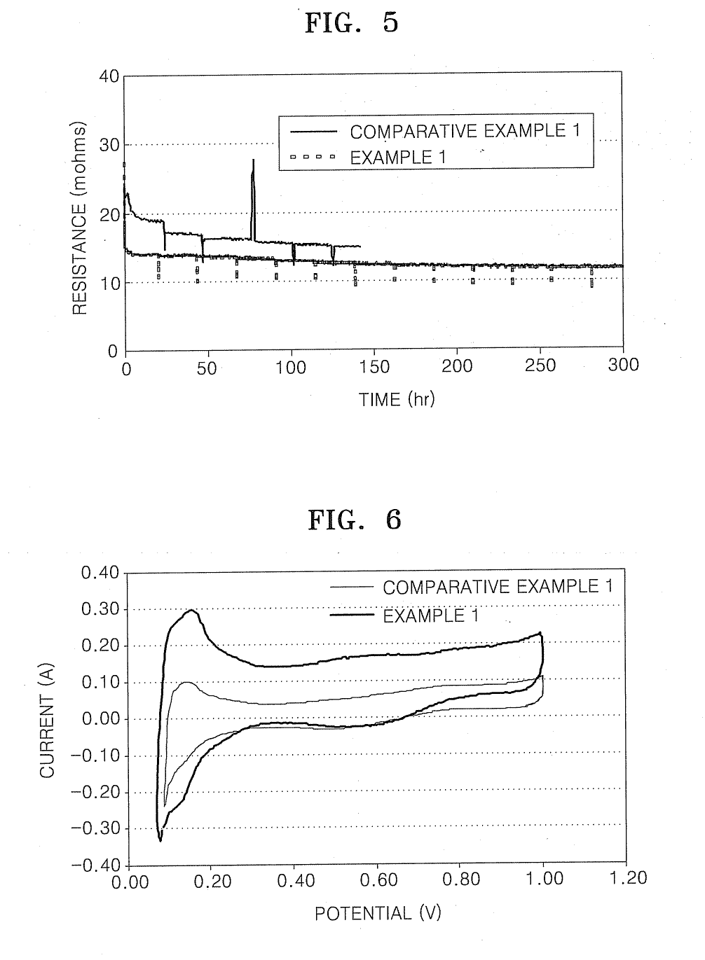

Regarding each of the fuel cells manufactured according to Example 1 and Comparative Example 1, cyclo voltammetry (CV) was measured, and the results are shown in FIG. 6. Referring to FIG. 6, it was confirmed that a Pt effective area of the fuel cell of Example 1 is wider than that of the fuel cell of Comparative Example 1.

Regarding each of the fuel cells manufactured according to Example 1 and Comparative Example 1, a Pt utilization ratio of a MEA was evaluated, and the results are shown in Table 2 below.

TABLE 2

| | Pt utilization ratio (%) |
|---|---|
| Example 1 | 63 |
| Comparative | 18 |
| Example 1 | |

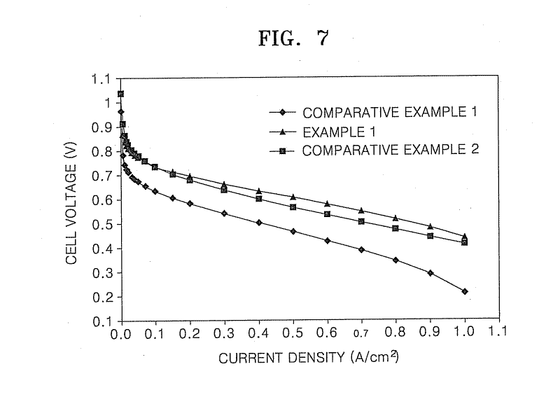

Regarding each of the fuel cells manufactured according to Example 1 and Comparative Examples 1 and 2, cell voltage characteristics with respect to current density were evaluated, and the results are shown in FIG. 7. Referring to FIG. 7, it was confirmed that the fuel cell of Example 1 has better cell voltage characteristics than the fuel cells of Comparative Examples 1 and 2.

As described above, the CCM for a fuel cell according to the one or more of the above embodiments of the present invention has a high catalyst utilization ratio and good proton conductivity characteristics. If an MEA including the CCM is used to manufacture a fuel cell, the fuel cell has good cell performance.

It should be understood that the exemplary embodiments described herein should be considered in a descriptive sense only and not for purposes of limitation. Descriptions of features or aspects within each embodiment should typically be considered as available for other similar features or aspects in other embodiments.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A catalyst coated membrane for a fuel cell, the catalyst coated membrane comprising;
an electrolyte membrane; and
a catalyst layer formed on at least one surface of the electrolyte membrane.

2. The catalyst coated membrane of claim 1, wherein the thickness deviation of the catalyst layer is 20% or less.

3. The catalyst coated membrane of claim 1, wherein the utilization ratio of the catalyst layer is 40% or more.

4. The catalyst coated membrane of claim 1, wherein the electrolyte membrane is a phosphoric acid-based material doped electrolyte membrane.

5. The catalyst coated membrane of claim 4, wherein the doping concentration of the phosphoric acid-based material is about 100 to about 800 parts by weight based on 100 parts by weight of the electrolyte membrane.

6. The catalyst coated membrane of claim 1, wherein the catalyst layer comprises a catalyst, a binder, a phosphoric acid-based material, and water.

7. The catalyst coated membrane of claim 6, wherein the amount of the phosphoric acid-based material in the catalyst layer is about 0.1 to about 4 parts by weight based on 1 part by weight of the catalyst.

8. The catalyst coated membrane of claim 6, wherein the amount of the water in the catalyst layer is about 1 to about 5 parts by weight based on 1 part by weight of the catalyst.

9. The catalyst coated membrane of claim 6, wherein the amount of the binder in the catalyst layer is about 0.001 to about 0.5 parts by weight based on 1 part by weight of the catalyst.

10. The catalyst coated membrane of claim 1, wherein the thickness ratio of the electrolyte membrane to the catalyst layer is about 1:1 to about 1:2.

11. A membrane and electrode assembly for a fuel cell, the membrane and electrode assembly comprising:
the catalyst coated membrane of claim 1; and
an electrode support attached to the catalyst layer of the catalyst coated membrane.

12. The membrane and electrode assembly of claim 11, wherein the cell resistance of the membrane and electrode assembly is about 50 to about 200 mΩ*cm².

13. The membrane and electrode assembly of claim 11, wherein the amount of the catalyst on the electrolyte membrane after the electrode support is separated from the electrolyte membrane is about 45 to about 100 parts by weight based on 100 parts by weight of the total weight of the catalyst in the catalyst layer before the electrode support is separated from the electrolyte membrane.

14. The membrane and electrode assembly of claim 10, wherein the electrode support comprises:
a gas diffusion layer; and
a microporous layer comprising a conductive material and a binder.

15. A method of manufacturing a membrane and electrode assembly for a fuel cell, the method comprising:
coating a composition for forming a catalyst layer comprising a catalyst, water, a phosphoric acid-based material, and a binder on an electrolyte membrane and drying the composition, thereby forming a catalyst coated membrane comprising a catalyst layer; and
attaching an electrode support to the catalyst layer of the catalyst coated membrane.

16. The method of claim 15, wherein the drying is performed at a temperature of about 0 to about 80° C.

17. The method of claim 15, wherein the amount of the phosphoric acid-based material is about 0.1 to about 4 parts by weight based on 1 part by weight of the catalyst.

18. The method of claim 15, wherein the amount of the water is about 1 to about 5 parts by weight based on 1 part by weight of the catalyst.

19. A fuel cell comprising a membrane and electrode assembly for a fuel cell, the membrane and electrode assembly comprising:
the catalyst coated membrane of claim 1; and
an electrode support attached to the catalyst layer of the catalyst coated membrane.
